(19) United States
(12) Patent Application Publication
(10) Pub. No.: US 2024/0154504 A1
(43) Pub. Date: May 9, 2024

(54) MOTOR, COMPRESSOR, REFRIGERATION CYCLE APPARATUS, MAGNETIZING METHOD, AND MAGNETIZING APPARATUS

(71) Applicant: Mitsubishi Electric Corporation, Tokyo (JP)

(72) Inventors: Atsushi ISHIKAWA, Tokyo (JP); Atsushi MATSUOKA, Tokyo (JP)

(21) Appl. No.: 18/550,381

(22) PCT Filed: Apr. 12, 2021
(86) PCT No.: PCT/JP2021/015165

§ 371 Date: Sep. 13, 2023

(51) Int. Cl. H02K 11/33; H02K 1/02; H02K 1/276; H02K 15/03

(52) U.S. Cl. CPC H02K 11/33; H02K 1/02; H02K 1/276; H02K 15/03

(57) ABSTRACT

Rotor has P magnetic poles each formed by a permanent magnet. Three-phase coils are wound on a stator core in distribution winding. The three-phase coils have a first phase coil disposed on the outermost side, a second phase coil disposed on the innermost side, and a third phase coil disposed therebetween. Each coil has P winding portions. The permanent magnet is magnetized by a first magnetizing step performed in a state where the rotor is rotated by an angle θ in a first direction, and a second magnetizing step performed in a state where the rotor is rotated by the angle θ in a second direction. In each magnetizing step, the third phase coil is opened, the first and second phase coils are connected in series, and magnetization current is applied to the first and second phase coils.

### CROSS REFERENCE TO RELATED APPLICATION

This application is a U.S. national stage application of PCT/JP2021/015165 filed on Apr. 12, 2021, the contents of which are incorporated herein by reference.

### TECHNICAL FIELD

The present disclosure relates to a motor, a compressor, a refrigeration cycle apparatus, a magnetizing method, and a magnetizing apparatus.

### BACKGROUND

As a method for magnetizing a permanent magnet in a motor, there is a known method which involves incorporating a permanent magnet before magnetization into a motor and then magnetizing the permanent magnet by applying a magnetization current to coils of the motor. Such a magnetizing method is called built-in magnetization.

Since a large magnetization current is applied to the coils during a magnetizing step of the permanent magnet, an electromagnetic force may act on the coils to cause deformation, and may result in damage to the coils. Patent Reference 1 discloses arranging the coils dispersedly in the circumferential direction to thereby suppress damage to the coils during the magnetizing step.

### PATENT REFERENCE

Patent Reference 1: International Publication No. WO 2020/089994 (see, for example, paragraphs 0115-0121)

In recent years, due to the demand for higher efficiency of motors, there is a need to magnetize a permanent magnet more uniformly. That is, there is a need to magnetize the permanent magnet more uniformly while suppressing damage to the coils of the motor.

### SUMMARY

The present disclosure has an object to make it possible to magnetize a permanent magnet more uniformly while suppressing damage to the coils of a motor.

A motor according to the present disclosure includes a rotor having P magnetic poles each of which is formed by a permanent magnet, the rotor being rotatable about an axis, and a stator having a stator core surrounding the rotor from outside in a radial direction about the axis and three-phase coils wound on the stator core in distribution winding. The stator core has a plurality of slots in a circumferential direction about the axis. The three-phase coils have a first phase coil disposed on an outermost side in the radial direction, a second phase coil disposed on an innermost side in the radial direction, and a third phase coil disposed between the first phase coil and the second phase coil. Each of the first phase coil, the second phase coil and the third phase coil has P winding portions, adjacent two winding portions of the P winding portions being inserted into one slot of a plurality of slots and extending in both directions in the circumferential direction from the one slot. The permanent magnet is magnetized by a first magnetizing step performed in a state where the rotor is rotated by an angle θ in a first direction with respect to a reference position, and a second magnetizing step performed in a state where the rotor is rotated by the angle θ in a second direction with respect to the reference position. In each of the first magnetizing step and the second magnetizing step, the third phase coil is opened, the first phase coil and the second phase coil are connected in series, and magnetization current is applied to the first phase coil and the second phase coil.

According to the present disclosure, the first phase coil, the second phase coil and the third phase coil ae arranged from the inner side in the radial direction in this order, and the adjacent winding portions of the respective phase coils extend in both directions in the circumferential direction from one slot. The magnetization process is performed twice by rotating the rotor by the angle θ in the first direction and in the second direction. In each magnetization process, the magnetization current is applied to the first phase coil and the second phase coil which are connected in series. Therefore, the permanent magnet can be magnetized more uniformly while restraining the electromagnetic force acting on each phase coil to suppress damage to each phase coil.

### BRIEF DESCRIPTION OF THE DRAWINGS

FIG. 1 is a cross-sectional view illustrating a motor of a first embodiment.

FIG. 2 is a cross-sectional view illustrating a rotor of the first embodiment.

FIG. 3 is an enlarged cross-sectional view illustrating a part of the rotor of the first embodiment.

FIG. 4 is a top view illustrating a stator of the first embodiment.

FIG. 5 is a perspective view illustrating the stator of the first embodiment.

FIG. 6 is a schematic diagram illustrating a magnetizing apparatus of the first embodiment.

FIG. 7(A) is a diagram illustrating the magnetizing apparatus of the first embodiment, and FIG. 7(B) is a graph showing a magnetization current.

FIG. 8 is a flowchart illustrating a magnetizing method of the first embodiment.

FIGS. 9(A), 9(B) and 9(C) are schematic diagrams illustrating the magnetizing method of the first embodiment.

FIG. 10(A) is a schematic diagram illustrating a power source unit of the magnetizing apparatus of the first embodiment, and FIGS. 10(B) and 10(C) are schematic diagrams for explaining first and second magnetizing steps.

FIG. 11(A) is a diagram illustrating a general magnetizing yoke, and FIG. 11(B) is a diagram illustrating a magnetizing apparatus including the magnetizing yoke.

FIG. 12 is a top view illustrating a stator of Comparative Example.

FIG. 13 is a perspective view illustrating the stator of Comparative Example.

FIG. 14(A) is a schematic diagram illustrating a power source unit of a magnetizing apparatus of Comparative Example, and FIG. 14(B) is a schematic diagram for explaining a magnetizing step.

FIGS. 15(A), 15(B) and 15(C) are schematic diagrams for explaining an electromagnetic force acting on coils due to a magnetization current.

FIG. 16(A) is a diagram illustrating the magnetizing flux when a rotor is incorporated inside the stator of Comparative Example and a one-time magnetization is performed by energizing three-phase coils, and FIG. 16(B) is a diagram illustrating the magnetization distribution of a permanent magnet.

FIG. 17(A) is a diagram illustrating the magnetizing flux when the one-time magnetization is performed by energizing two-phase coils in the motor of the first embodiment, and FIG. 17(B) is a diagram illustrating the magnetization distribution of a permanent magnet.

FIGS. 18(A) and 18(B) are diagrams illustrating the magnetizing flux when a two-time magnetization is performed by energizing the two-phase coils in the motor of the first embodiment, and FIG. 18(C) is a diagram illustrating the magnetization distribution of the permanent magnet.

FIG. 19 is a graph showing the relationship between the angle of the rotor with respect to the reference position in a magnetizing step and the magnetomotive force required to obtain a magnetization ratio of 99.7%.

FIGS. 20(A), 20(B) and 20(C) are graphs showing electromagnetic forces acting on the three-phase coils in a case where the rotor is incorporated inside the stator of Comparative Example and the one-time magnetization is performed by energizing the three-phase coils, in a case where the rotor is incorporated inside the stator of Comparative Example and the two-time magnetization is performed by energizing the two-phase coils, and in a case where the two-time magnetization is performed by energizing the two-phase coils in the motor of the first embodiment.

FIG. 21 is a schematic diagram illustrating electromagnetic forces acting on the coils in the magnetizing step of the first embodiment.

FIG. 22 is a table showing the effect of reducing the electromagnetic force in the first embodiment.

FIG. 23 is a cross-sectional view illustrating a rotor of a second embodiment.

FIG. 24(A) is an enlarged diagram illustrating a part of the rotor of the second embodiment, and FIG. 24(B) is an enlarged diagram illustrating a part of a rotor core.

FIG. 25 is an enlarged diagram illustrating end parts of permanent magnets and their surroundings of the second embodiment.

FIG. 26 is a graph showing the relationship between the width of the permanent magnet and the magnetomotive force required to obtain a magnetization ratio of 99.7% in each of the second embodiment and Comparative Example.

FIG. 27(A) is a diagram illustrating the end part of the permanent magnet of the rotor of the first embodiment, FIG. 27(B) is a diagram illustrating the magnetization distribution at the end part of the permanent magnet when the one-time magnetization is performed by energizing the three-phase coils, and FIG. 27(C) is a diagram illustrating the magnetization distribution at the end part of the permanent magnet when the two-time magnetization is performed by energizing the two-phase coils.

FIG. 28(A) is a diagram illustrating the end part of the permanent magnet of the rotor of the second embodiment, FIG. 28(B) is a diagram illustrating the magnetization distribution at the end part of the permanent magnet when the one-time magnetization is performed by energizing the three-phase coils, and FIG. 28(C) is a diagram illustrating the magnetization distribution at the end part of the permanent magnet when the two-time magnetization is performed by energizing the two-phase coils.

FIG. 29 is a diagram illustrating a compressor to which the motor of each embodiment is applicable.

FIG. 30 is a diagram illustrating a refrigeration cycle apparatus including the compressor illustrated in FIG. 29.

### DETAILED DESCRIPTION

### First Embodiment

### (Configuration of Motor)

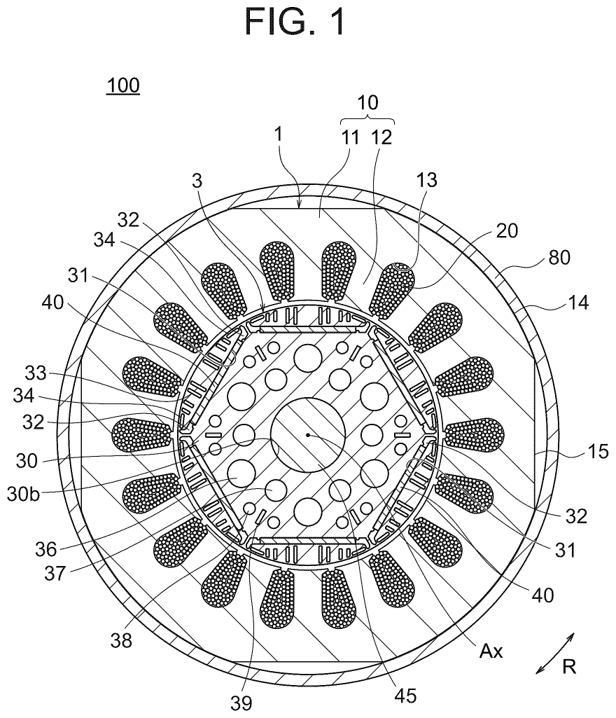

FIG. 1 is a cross-sectional view illustrating a motor 100 of a first embodiment. The motor 100 of the first embodiment includes a rotor 3 that is rotatable and a stator 1 that surrounds the rotor 3. An air gap of 0.25 to 1.25 mm is provided between the stator 1 and the rotor 3.

Hereinafter, the direction of an axis Ax, which is a rotation axis of the rotor 3, is referred to as an “axial direction”. The circumferential direction about the axis Ax is referred to as a “circumferential direction” and indicated by an arrow R in FIG. 1 and other figures. The radial direction about the axis Axis referred to as a “radial direction”. FIG. 1 illustrates a cross-section orthogonal to the axial direction.

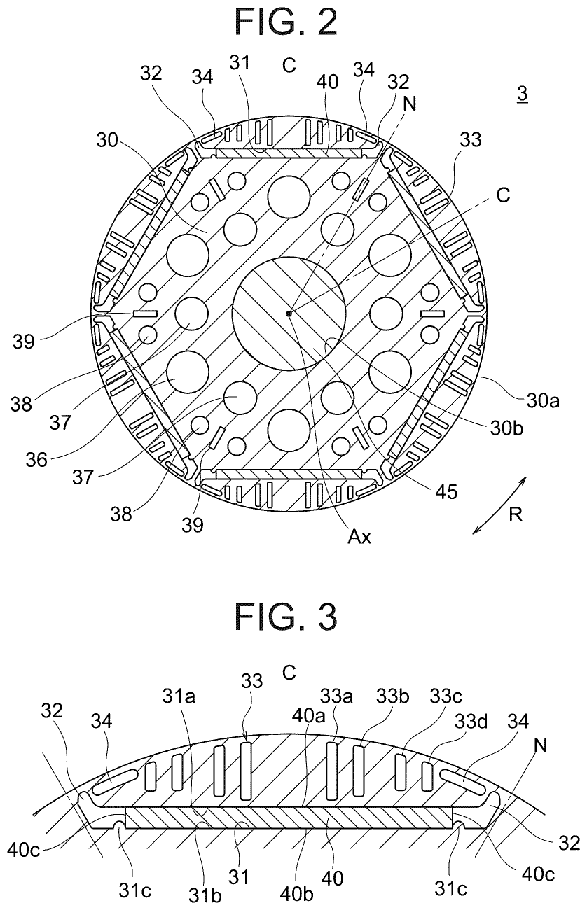

FIG. 2 is a cross-sectional view illustrating the rotor 3. The rotor 3 includes a rotor core 30 and permanent magnets 40 attached to the rotor core 30. The rotor core 30 has a cylindrical shape about the axis Ax. The rotor core 30 is composed of electromagnetic steel sheets which are stacked in the axial direction and integrally fixed by crimping, rivets, or the like. Each electromagnetic steel sheet has a thickness of, for example, 0.1 to 0.7 mm.

The rotor core 30 has an outer circumference 30a and an inner circumference 30b. A shaft 45 is fixed to the inner circumference 30b of the rotor core 30 by press-fitting. The center axis of the shaft 45 coincides with the axis Ax described above.

The rotor core 30 has a plurality of magnet insertion holes 31 along the outer circumference 30a. In this example, six magnet insertion holes 31 are arranged at equal intervals in the circumferential direction. One permanent magnet 40 is disposed in each magnet insertion hole 31.

Each permanent magnet 40 forms one magnetic pole. Since the number of permanent magnets 40 is six, the number of poles P of the rotor 3 is six. Incidentally, the number of poles P of the rotor 3 is not limited to six and only needs to be two or more. Two or more permanent magnets 40 may be disposed in each magnet insertion hole 31 so as to constitute one magnetic pole.

The center of each magnet insertion hole 31 in the circumferential direction is a pole center. A straight line in the radial direction that passes through the pole center is referred to as a pole center line C. The pole center line C is the d-axis of the rotor 3. An inter-pole portion N is defined between adjacent magnet insertion holes 31.

The permanent magnet 40 is a member in the form of a flat plate and has a width in the circumferential direction and a thickness in the radial direction. The permanent magnet 40 is a neodymium rare earth magnet containing neodymium (Nd), iron (Fe) and boron (B), and may further contain a heavy rare earth element such as dysprosium (Dy) or terbium (in). The permanent magnet 40 is magnetized in its thickness direction, i.e., the radial direction. The permanent magnets 40 adjacent to each other in the circumferential direction have magnetization directions opposite to each other.

FIG. 3 is an enlarged diagram illustrating a part of the rotor 3. The permanent magnet 40 has a magnetic pole surface 40a located on the outer side in the radial direction, a back surface 40b located on the inner side in the radial direction, and side end surfaces 40c located on both sides in the circumferential direction. Both the magnetic pole surface 40a and the back surface 40b are surfaces perpendicular to the pole centerline C. The thickness of the permanent magnet 40 is a distance between the magnetic pole surface 40a and the back surface 40b, and is, for example, 2.0 mm.

The magnet insertion hole 31 extends linearly in a direction perpendicular to the pole centerline C. The magnet insertion hole 31 has an outer edge 31a located on the outer side in the radial direction and an inner edge 31b located on the inner side in the radial direction. The outer edge 31a of the magnet insertion hole 31 faces the magnetic pole surface 40a of the permanent magnet 40, while the inner edge 31b of the magnet insertion hole 31 faces the back surface 40b of the permanent magnet 40.

Protrusions 31c that contact the side end surfaces 40c of the permanent magnet 40 are formed at both ends in the circumferential direction of the inner edge 31b of the magnet insertion hole 31. The protrusions 31c protrude from the inner edge 31b toward the inside of the magnet insertion hole 31. The protrusions 31c of the magnet insertion hole 31 restrict the position of the permanent magnet 40 in the magnet insertion hole 31.

Flux barriers 32 are formed at both ends of the magnet insertion hole 31 in the circumferential direction. Each flux barrier 32 is an opening extending in the radial direction from an end of the magnet insertion hole 31 in the circumferential direction toward the outer circumference of the rotor core 30. The flux barrier 32 acts to suppress the leakage of magnetic flux between the adjacent magnetic poles.

Slits 33 are formed on the outer side of the magnet insertion hole 31 in the radial direction. In this example, eight slits 33 that are elongated in the radial direction are formed symmetrically with respect to the pole center line C. Two slits 34 that are elongated in the circumferential direction are formed on both sides of a combination of the eight slits 33 in the circumferential direction. Incidentally, the number and arrangement of the slits 33 and 34 are not limited. The rotor core 30 may be configured to have no slits 33, 34.

As illustrated in FIG. 2, crimping portions 39 for integrally fixing the electromagnetic steel sheets constituting the rotor core 30 are formed on the inner side of the inter-pole portions in the radial direction. Incidentally, the positions of the crimping portions 39 are not limited to these positions.

Through holes 36 are formed on the inner side of the magnet insertion holes 31 in the radial direction, and through holes 37 are formed on the inner side of the crimping portions 39 in the radial direction. Through holes 38 are formed on both sides of the crimping portion 39 in the circumferential direction. Each of the through holes 36, 37, and 38 extends from one end to the other end of the rotor core 30 in the axial direction and is used as a refrigerant flow path or a rivet hole. The positions of the through holes 36, 37, and 38 are not limited to these positions. The rotor core 30 may be configured to have no through holes 36, 37, 38.

As illustrated in FIG. 1, the stator 1 has a stator core 10 and coils 2 wound on the stator core 10. The stator core 10 is formed to have an annular shape about the axis Ax. The stator core 10 is composed of a plurality of electromagnetic steel sheets which are stacked in the axial direction and integrally fixed by crimping or the like. Each electromagnetic steel sheet has a sheet thickness of, for example, 0.1 to 0.7 mm.

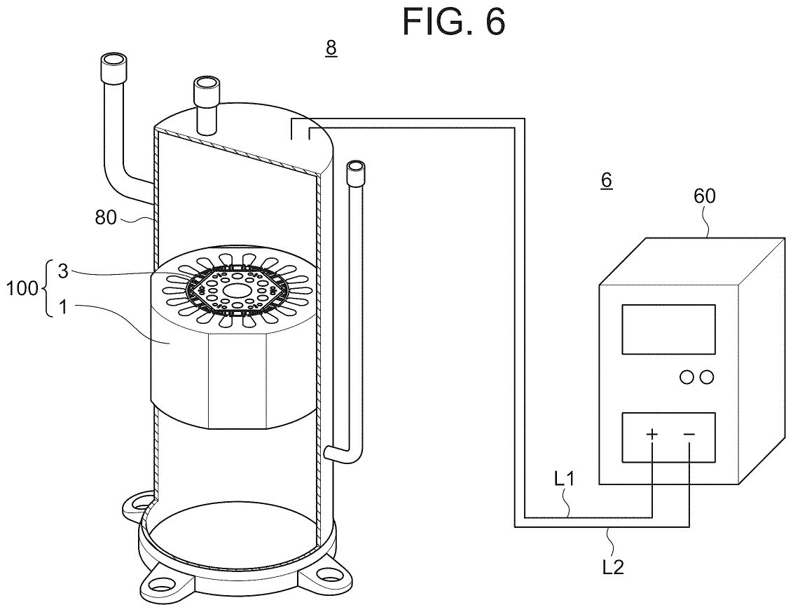

The stator core 10 includes an annular core back 11, and a plurality of teeth 12 extending inward in the radial direction from the core back 11. The core back 11 has an outer circumferential surface 14 which is a cylindrical surface about the axis Ax. The outer circumferential surface 14 of the core back 11 is fitted to an inner circumferential surface of a cylindrical shell 80. The shell 80 is a part of a compressor 8 (FIG. 6) and formed of a magnetic material.

The teeth 12 are formed at equal intervals in the circumferential direction. A tooth tip portion that is wide in the circumferential direction is formed at a tip of the tooth 12 on the inner side in the radial direction. The tooth tip portion of the tooth 12 faces the rotor 3. The coils 2 are wound around the teeth 12 in distribution winding. The number of teeth 12 is 18 in this example, but only needs to be two or more.

A slot 13 is formed between adjacent teeth 12. The number of slots 13 is the same as the number of teeth 12, and is 18 in this example. The coil 2 is housed in the slot 13.

D-cut portions 15, each of which is a plane portion parallel to the axis Ax, are formed at the outer circumferential surface 14 of the core back 11. Each D-cut portion 15 extends from one end to the other end of the stator core 10 in the axial direction. The D-cut portions 15 are formed at four locations at intervals of 90 degrees about the axis Ax. A gap is formed between the D-cut portion 15 and the inner circumferential surface of the shell 80. This gap serves as a flow path through which a refrigerant flows in the axial direction.

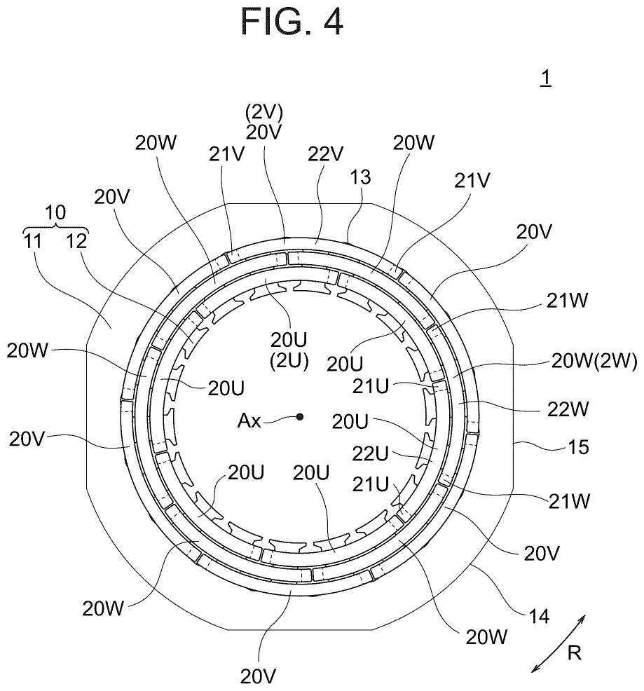

FIG. 4 is a top view illustrating the stator 1. Coils 2U, 2V, and 2W include a U-phase coil 2U as a first phase coil, a W-phase coil 2W as a second phase coil, and a V-phase coil 2V as a third phase coil. Each of the coils 2U, 2V, and 2W has a conductor made of aluminum or copper and an insulating film covering the conductor.

Each of the coils 2U, 2V, and 2W is arranged to form an annular shape about the axis Ax. The positions of the coils 2U, 2V, and 2W in the radial direction differ from one another. More specifically, the coil 2U is located on the innermost side in the radial direction, the coil 2V is located on the outermost side in the radial direction, and the coil 2W is located between the coils 2U and 2V in the radial direction. Thus, the coil 2U may be referred to as an inner layer coil, the coil 2V as an outer layer coil, and the coil 2W as a middle layer coil. The coils 2U, 2V, and 2W are referred to as the coils 2 where there is no need to distinguish among the coils 2U, 2V, and 2W.

The coil 2U has six winding portions 20U arranged in the circumferential direction. The number of winding portions 20U is the same as the number of poles P of the rotor 3. Each winding portion 20U has two coil sides 21U that are inserted into the slots 13 and two coil ends 22U that extend along the end surfaces of the stator core 10.

The winding portion 20U is wound at a three-slot pitch, in other words, every three slots. That is, one coil side 21U of the winding portion 20U is inserted into one slot 13, while the other coil side 21U of the winding portion 20U is inserted into the third slot counted from this slot 13. In other words, the winding portion 20U is wound to straddle two slots 13.

The coil sides 21U of the two adjacent winding portions 20U are inserted into the common slot 13. The coil ends 22U of these winding portions 20U extend in both directions in the circumferential direction from this common slot 13.

Similarly, the coil 2V has six winding portions 20V arranged in the circumferential direction. Each winding portion 20V has two coil sides 21V that are inserted into the slots 13 and two coil ends 22V that extend along the end surfaces of the stator core 10.

The winding portion 20V is wound at a three-slot pitch. The coil sides 21V of the two adjacent winding portions 20V are inserted into the common slot 13. The coil ends 22V of these winding portions 20V extend in both directions in the circumferential direction from this common slot 13.

Similarly, the coil 2W has six winding portions 20W arranged in the circumferential direction. Each winding portion 20W has two coil sides 21W that are inserted into the slots 13 and two coil ends 22W that extend along the end surfaces of the stator core 10.

The winding portion 20W is wound at a three-slot pitch. The coil sides 21W of the two adjacent winding portions 20W are inserted into the common slot 13. The coil ends 22W of these winding portions 20W extend in both directions in the circumferential direction from this common slot 13.

Incidentally, the slot 13 into which the coil sides 21W of the winding portion 20W are inserted is counterclockwise adjacent to the slot 13 into which the coil sides 21U of the winding portion 20U are inserted. The slot 13 in which the coil sides 21V of the winding portion 20V are inserted is counterclockwise adjacent to the slot 13 in which the coil sides 21W of the winding portion 20W are inserted. Thus, two coil sides are inserted into every slot 13 of the stator core 10.

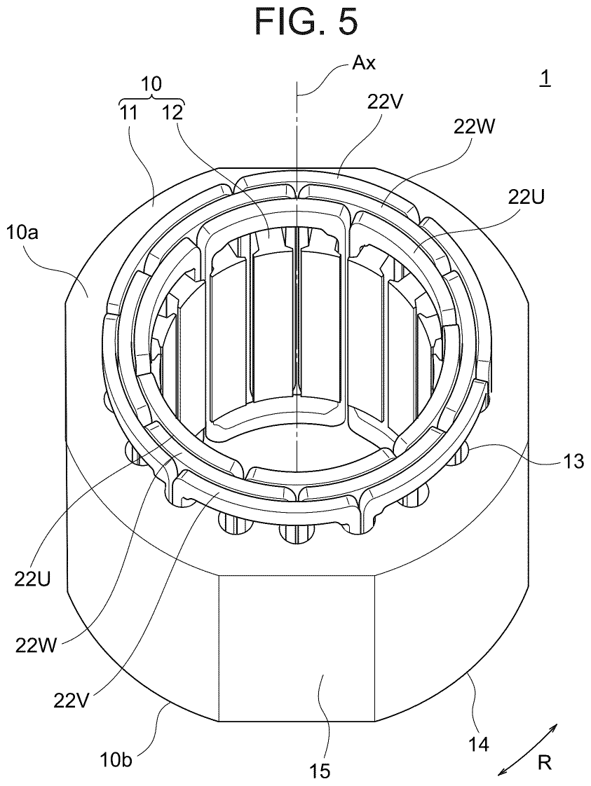

FIG. 5 is a perspective view illustrating the stator 1. The coil ends 22U, 22W, and 22V are arranged on one end surface 10a of the stator core 10 in the axial direction. The coil end 22W is located on the outer side of the coil end 22U in the radial direction, and the coil end 22V is located on the outer side of the coil end 22W in the radial direction. Although not shown in FIG. 5, the coil ends 22U, 22W, and 22V are also arranged in the same manner on the other end surface 10b of the stator core 10 in the axial direction.

Here, the action of the above-described arrangement of the coils 2U, 2V, and 2W in the stator 1 of the first embodiment will be explained. In the explanation of the features common to the coils 2U, 2V, and 2W, the reference characters U, V, and W are omitted. The same goes for the winding portions 20U, 20V, and 20W, the coil sides 21U, 21V, and 21W, and the coil ends 22U, 22V, and 22W.

As described above, the stator core 10 has 18 slots 13, and the coil 2 has 6 winding portions 20. Thus, number of slots per pole per phase is one. That is, for one magnetic pole, three phase coils 2U, 2V, and 2W are housed in three slots 13.

The number of winding portions 20 of the coil 2 is the same as the number of poles P. The winding portion 20 is wound at a three-slot pitch. The slot pitch is 360°×3/18=60° in machine angle. The magnetic pole pitch of the rotor 3 is 60° in machine angle. Since the slot pitch and the magnetic pole pitch match each other, the winding factor is 1.

The coil sides 21 of the two adjacent winding portions 20 of the coil 2 are housed in the common slot 13. The coil ends 22 extend in both directions (clockwise and counterclockwise) in the circumferential direction from this common slot 13.

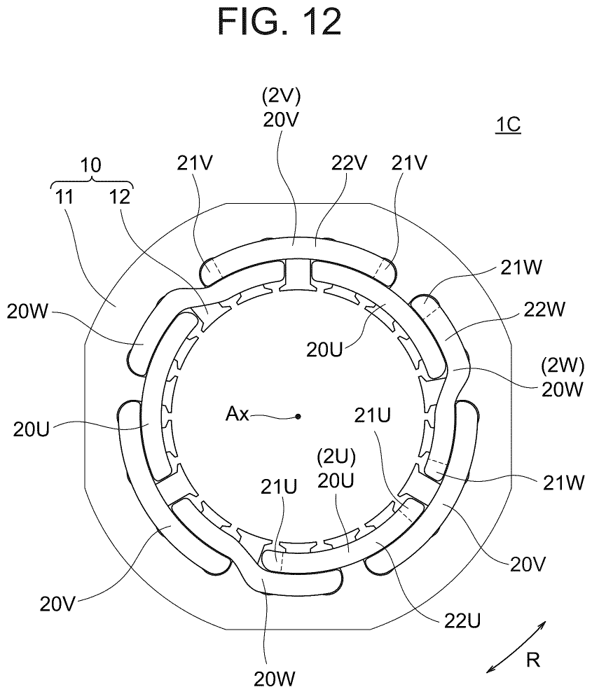

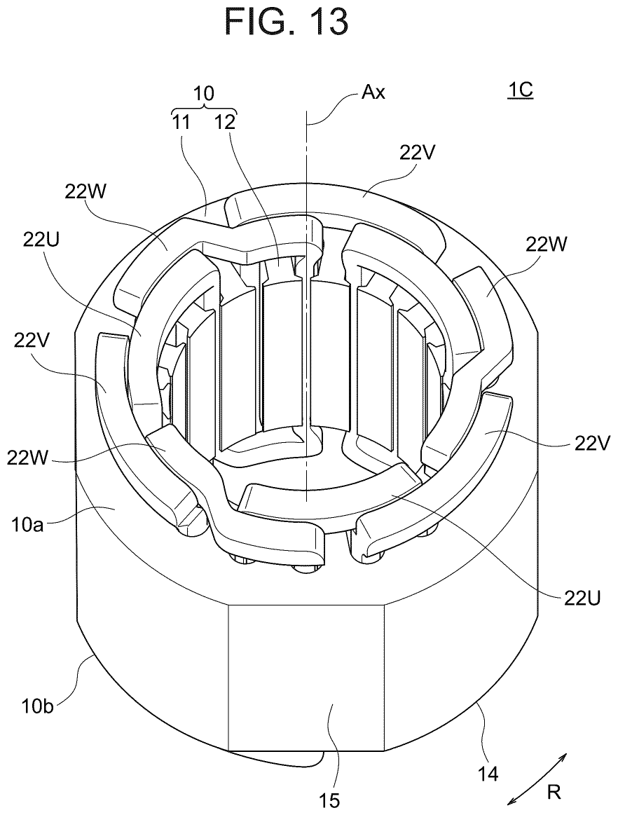

Generally, in order to achieve a three-phase six-pole motor in which coils 2 are wound in the distribution winding, the number of winding portions 20 of the coil 2 is set to three, which is half the number of poles P, as shown in FIGS. 12 and 13 described later. Also in this case, the slot pitch of the stator 1 is 60°, and thus the winding factor is 1 and the magnetic flux of the permanent magnet 40 can be used effectively. However, since the number of winding portions 20 of the coil 2 is three, each winding portion 20 is made large, and the average circumference of the coil 2 is made long.

In contrast, in the first embodiment, the slot pitch of the stator 1 is the same as above, but the coil 2 is arranged dispersedly over six winding portions 20, and thus the winding portions 20 can be reduced in size while maintaining the winding factor at 1. Thus, the average circumference of the coil 2 is shortened, so that the winding resistance can be reduced. Due to the reduction in the winding resistance, the loss in the coil 2 is reduced, and the efficiency of the motor 100 is improved.

Since the average circumference of the coil 2 is shortened, the conductor (lead wire) of the coil 2 can also be made thinner without increasing the winding resistance, so that the use amount of the conductor can be decreased. Thus, the material cost can be reduced while maintaining the performance of the motor 100. Furthermore, since the coil 2 is arranged dispersedly over six winding portions 20, it is possible to conform to various types of specifications of the coil 2 by appropriately combining of the winding portions 20.

### (Magnetizing Apparatus)

FIG. 6 is a diagram illustrating a magnetizing apparatus 6 for magnetizing the permanent magnet 40. In the first embodiment, the rotor 3 having the permanent magnets 40 before magnetization is incorporated inside the stator 1 to constitute the motor 100, and then the permanent magnets 40 are magnetized in a state where the motor 100 is incorporated in a compressor 8. For convenience of explanation, the permanent magnet before the magnetization (i.e., the magnetic material) is also referred to as a “permanent magnet”.

The magnetizing apparatus 6 has a power source unit 60 as a power source for magnetization. The power source unit 60 is connected to the coils 2 of the motor 100 in the compressor 8 by wires L1 and L2.

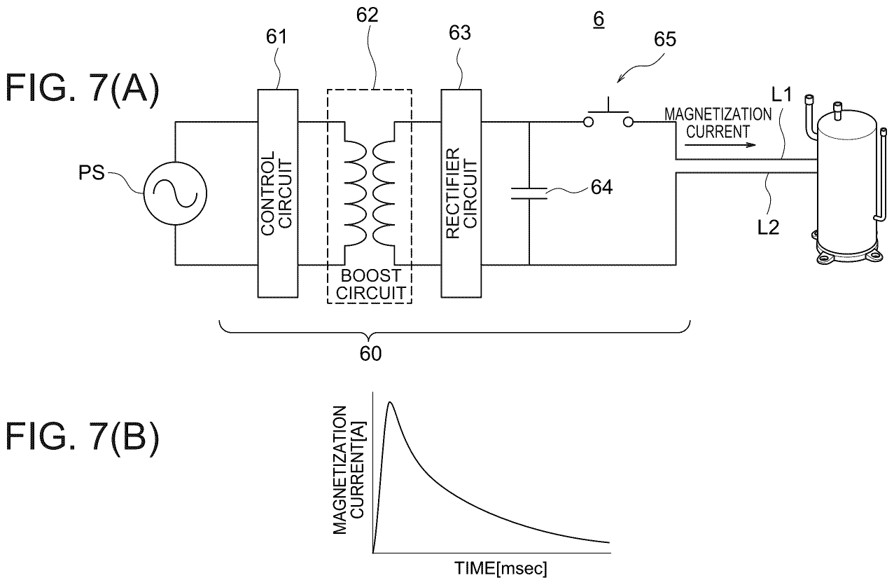

FIG. 7(A) is a diagram illustrating the configuration of the power source unit 60. The power supply unit 60 has a control circuit 61, a boost circuit 62, a rectifier circuit 63, a capacitor 64, and a switch 65.

The control circuit 61 controls the phase of an AC voltage supplied from an AC power source PS which is a commercial power source. The boost circuit 62 boosts an output voltage of the control circuit 61. The rectifier circuit 63 converts the AC voltage into a DC voltage. The capacitor 64 accumulates charge. The switch 65 is a switch for discharging the charge accumulated in the capacitor 64.

The magnetization current generated in the power source unit 60 is supplied to the coils 2 of the motor 100 via the wires L1 and L2. The waveform of the magnetization current supplied from the power source unit 60 to the coils 2 has a high peak of for example, several kA, immediately after the switch 65 is turned ON, as illustrated in FIG. 7(B).

### (Magnetizing Method)

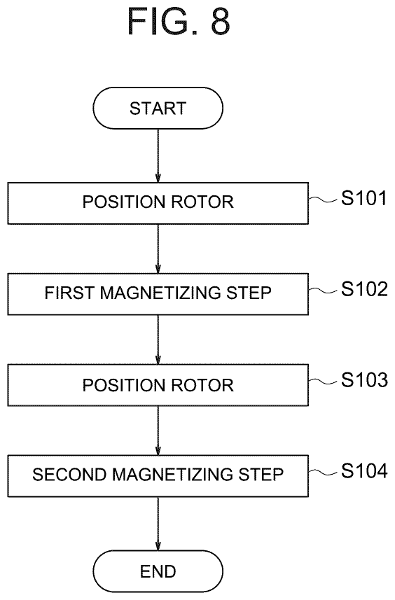

Next, the magnetizing method of the first embodiment will be described. FIG. 8 is a flowchart illustrating the magnetizing method of the first embodiment. Before executing the process of FIG. 8, the rotor 3 having the permanent magnets 40 before magnetization is incorporated inside the stator 1 to constitute the motor 100, and then the motor 100 is incorporated in the compressor 8. The wires L1 and L2 of the power source unit 60 are connected to the coils 2 of the motor 100.

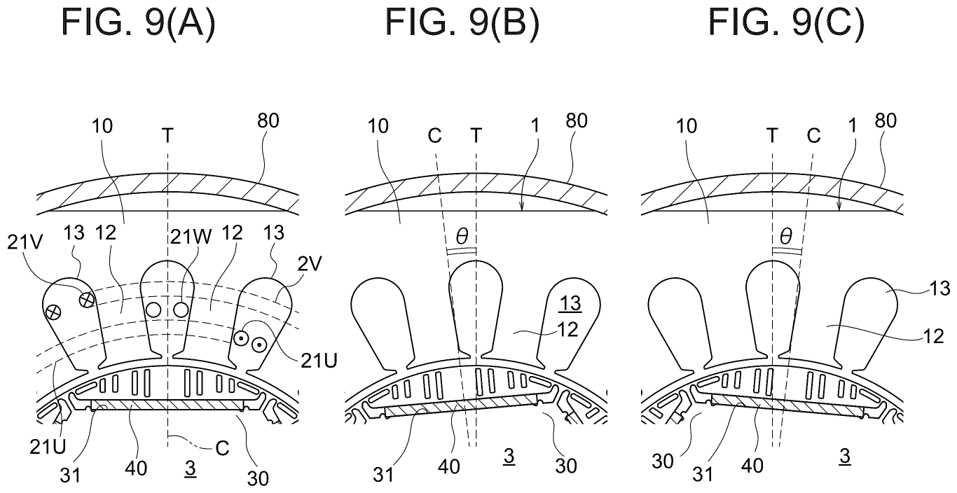

FIGS. 9(A), 9(B), and 9(C) are schematic diagrams illustrating the positional relationship between the stator 1 and the rotor 3. FIG. 9(A) illustrates a state in which the rotor 3 is located at a reference position.

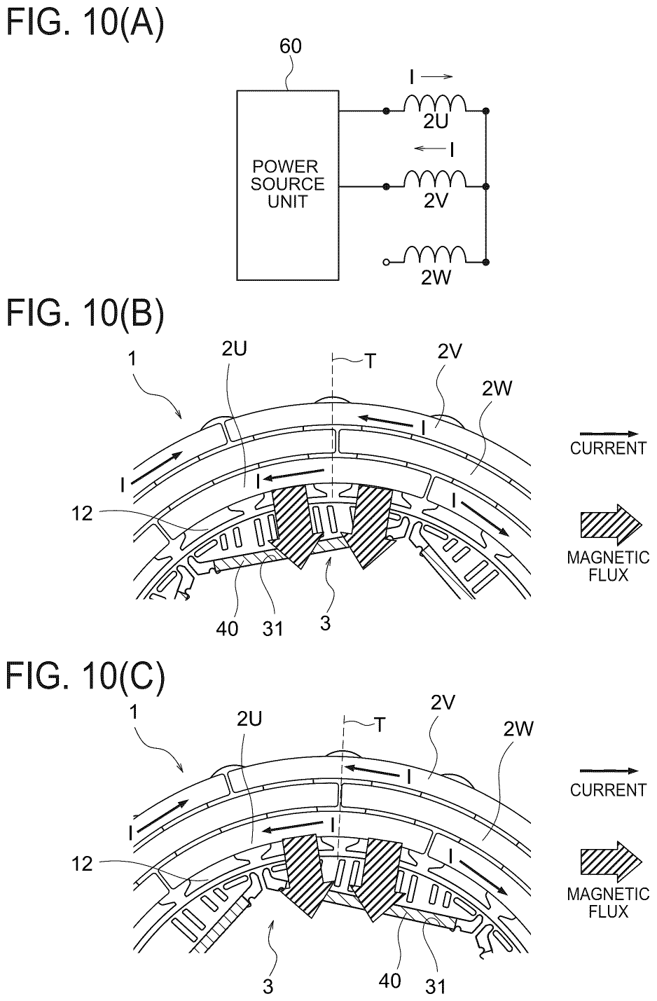

In FIG. 9(A), a straight line denoted by reference character T is a straight line in the radial direction passing through the center of the magnetizing flux, and is referred to a “magnetizing flux center line T”. The magnetizing flux is generated by opening the coil 2W, connecting the coils 2U and 2V in series, and applying magnetization current to the coils 2U and 2V as mentioned later (FIG. 10(A)).

Thus, the magnetizing flux center line T passes through the middle position in the circumferential direction between the two slots 13 in which the mutually closer coil sides 21U and 21V of the coils 2U and 2V are inserted. In other words, the straight line T passes through the center position in the circumferential direction of the slot 13 in which the coil sides 21W of the coil 2W are inserted.

When the rotor 3 is located at the reference position illustrated in FIG. 9(A), the center of the permanent magnet 40 in the circumferential direction, i.e., the pole center, faces the center of the magnetizing flux generated by the magnetization current. In other words, when the rotor 3 is located at the reference position, the pole center line C (d-axis) coincides with the magnetizing flux center line T.

The magnetization of the permanent magnets 40 is performed by a first magnetizing step and a second magnetizing step. In the first magnetizing step, as illustrated in FIG. 9(B), the rotor 3 is rotated by an angle θ in a first direction with respect to the reference position (step S101 illustrated in FIG. 8). In this example, the first direction is counterclockwise in the figure. The angle θ is, for example, 5 to 10 degrees.

In this state, the magnetization current is applied from the power source unit 60 to the coils 2U and 2V (step S102). The magnetizing flux is generated by the magnetization current applied to the coils 2, and the magnetizing flux flows through the permanent magnets 40 to magnetize the permanent magnets 40.

In the second magnetizing step, as illustrated in FIG. 9(C), the rotor 3 is rotated by the angle θ in a second direction with respect to the reference position (step S103 illustrated in FIG. 8). In this example, the second direction is clockwise in the figure. The angle θ is the same as the angle θ in the first magnetizing step, and is, for example, 5 to 10 degrees.

In this state, the magnetization current is applied from the power source unit 60 to the coils 2U and 2V (step S104). The magnetizing flux is generated by the magnetization current applied to the coils 2, and the magnetizing flux flows through the permanent magnets 40 to magnetize the permanent magnets 40.

When the magnetization of the permanent magnets 40 is completed, the wires L1 and L2 of the power source unit 60 are detached from the coils 2 of the motor 100. Thus, the process illustrated in FIG. 8 is completed.

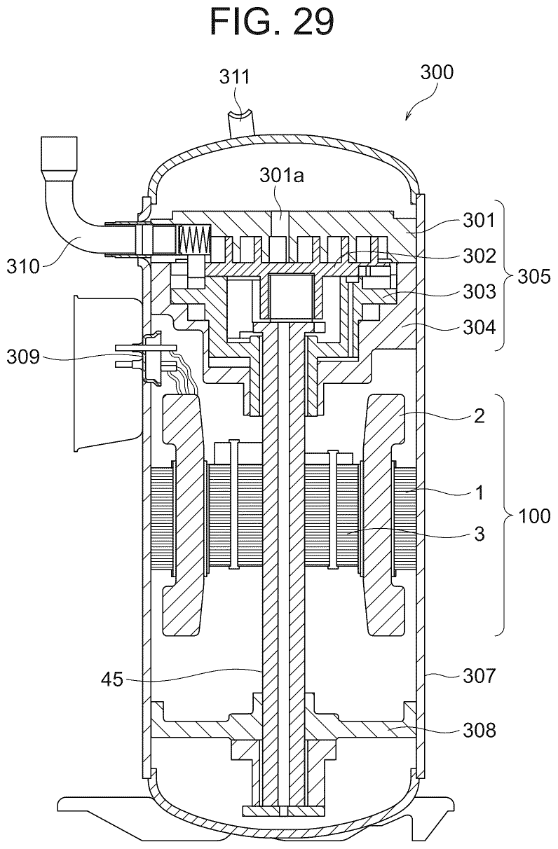

FIG. 10(A) is a diagram illustrating the connection state between the power source unit 60 of the magnetizing apparatus 6 and the coils 2U, 2V, and 2W. In the above-mentioned first magnetizing step and second magnetizing step, the coil 2W which is the middle layer coil is opened, the coil 2U which is the inner layer coil and the coil 2V which is the outer layer coil are connected in series, and the magnetization current is applied to the coils 2U and 2V. The series connection of the coils 2U and 2V and the opening of the coil 2W can be achieved, for example, by a terminal of the compressor 8. The terminal is, for example, a glass terminal 309 illustrated in FIG. 29.

FIG. 10(B) is a schematic diagram illustrating the magnetization current and the magnetizing flux in the first magnetizing step. The magnetization current is applied to the coils 2U and 2V, while no magnetization current is applied to the coil 2W as described above. The magnetization currents I in the same direction flow in the winding portions 20U and 20V of the coils 2U and 2V that face one permanent magnet 40. The magnetizing flux is generated by the magnetization current I and flows through the permanent magnet 40.

FIG. 10(C) is a schematic diagram illustrating the magnetization current and the magnetizing flux in the second magnetizing step. As in the first magnetizing step, the magnetization current is applied to the coils 2U and 2V, while no magnetization current is applied to the coil 2W. The magnetization currents I in the same direction flow in the winding portions 20U and 20V of the coils 2U and 2V that face one permanent magnet 40. The magnetizing flux is generated by the magnetization current I and flows through the permanent magnet 40.

In the first magnetizing step and the second magnetizing step, the angles of the permanent magnet 40 with respect to the magnetizing flux center line T are opposite to each other. In the first magnetizing step, a region on one end side (in this example, on the right side in the figure) of the permanent magnet 40 is particularly magnetized. In the second magnetization process, a region on the other end side (in this example, on the left side in the figure) of the permanent magnet 40 is particularly magnetized.

Thus, the magnetization can be performed in such a manner that the direction of the magnetizing flux and the easy magnetization direction of the permanent magnet 40 are closer to being parallel to each other on both of one end side and the other end side of the permanent magnet 40. The easy magnetization direction of the permanent magnet 40 is the thickness direction of the permanent magnet 40. The end side refers to a range from the center part to the end part of the permanent magnet 40 in the width direction.

As illustrated in FIGS. 9(B) and 9(C), the act of performing the first magnetizing step and the second magnetizing step while changing the rotating position of the rotor 3 is referred to as a two-time magnetization. In contrast, the act of performing the magnetizing step once while placing the rotor 3 at the reference position of FIG. 9(A) is referred to as a one-time magnetization.

### (General Magnetizing Apparatus)

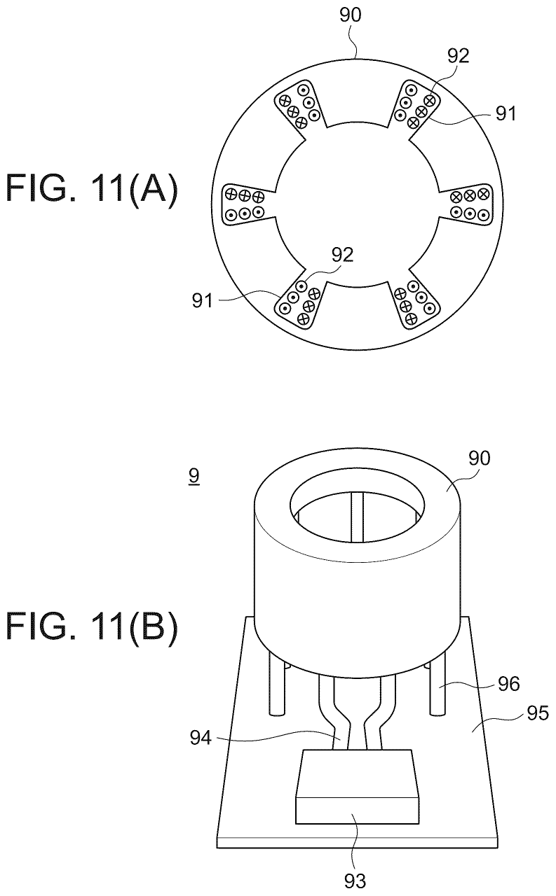

Prior to the description of the action of the first embodiment, a general magnetizing apparatus will be described. FIG. 11(A) is a cross-sectional view illustrating a magnetizing yoke 90 of a general magnetizing apparatus 9, and FIG. 11(B) is a diagram illustrating the entire magnetizing apparatus 9.

The magnetizing apparatus 9 magnetizes the permanent magnets 40 not by using the coils 2 of the stator 1, but using coils 92 of the dedicated magnetizing yoke 90 illustrated in FIG. 11(A). The magnetizing yoke 90 is an annular magnetic member formed of a magnetic material and has six slots 91 in the circumferential direction. The coils 92 are wound on the magnetizing yoke 90.

As illustrated in FIG. 11(B), the magnetizing apparatus 9 has a power source unit 93, lead wires 94 that connect the power supply unit 93 and the coils 92, a base 95, and support members 96 that support the magnetizing yoke 90 on the base 95.

When magnetizing the permanent magnets 40, the rotor 3 having the permanent magnets 40 before magnetization is placed inside the magnetizing yoke 90. By applying the magnetization current from the power supply unit 93 to the coils 92, the magnetizing magnetic field is generated in the magnetizing yoke 90, thereby magnetizing the permanent magnets 40 of the rotor 3.

The magnetizing yoke 90 is designed to be dedicated for magnetizing the permanent magnets 40, and the coils 92 can be made thick enough to enhance their strength. Thus, the coils 92 are less likely to be damaged even when the electromagnetic force is generated by applying the magnetization current to the coils 92.

However, in the case where the magnetizing yoke 90 is used, the rotor 3 needs to be incorporated inside the stator 1 after the permanent magnets 40 are magnetized. At this time, a strong magnetic attractive force acts between the rotor 3 and the stator 1. This magnetic attractive force makes it difficult to incorporate the rotor 3 inside the stator 1, thus the ease of assembly of the motor 100 is reduced.

Further, due to the magnetic force of the permanent magnets 40, iron powder or the like may adhere to the rotor 3. If the rotor 3 is incorporated inside the stator 1 in a state where iron powder or the like adheres to the rotor 3, it may cause the performance of the motor 100 to deteriorate.

### Comparative Example

FIG. 12 is a top view illustrating a stator 1C of Comparative Example. The stator 1C has a stator core 10 and coils 2U, 2V, and 2W wound on the stator core 10 in distribution winding. The stator core 10 has the same configuration as the stator core 10 of the first embodiment.

The coils 2U, 2V, and 2W include a U-phase coil 2U, a W-phase coil 2W, and a V-phase coil 2V. The coil 2U is located on the innermost side in the radial direction, i.e., the inner circumferential side, and the coil 2V is located on the outermost side in the radial direction, i.e., the outer circumferential side. The coil 2W is drawn from the outer circumferential side of the coil 2U to the inner circumferential side of the coil 2V.

The coil 2U has three winding portions 20U. The number of winding portions 20U is half the number of poles P of the rotor 3. Each winding portion 20U has two coil sides 21U that are inserted into the slots 13 and two coil ends 22U that extend along the end surfaces of the stator core 10.

The coil 2V has three winding portions 20V. Each winding portion 20V has two coil sides 21V that are inserted into the slots 13 and two coil ends 22V that extend along the end surfaces of the stator core 10.

Similarly, the coil 2W has three winding portions 20W. Each winding portion 20W has two coil sides 21W that are inserted into the slots 13 and two coil ends 22W that extend along the end surfaces of the stator core 10.

FIG. 13 is a perspective view illustrating the stator 1C. The coil ends 22U, 22W, and 22V are disposed on the end surfaces 10a and 10b of the stator core 10. The coil end 22U is disposed on the inner circumferential side, the coil end 22V is disposed on the outer circumferential side, and the coil end 22W is drawn from the outer circumferential side of the coil end 22U to the inner circumferential side of the coil end 22V.

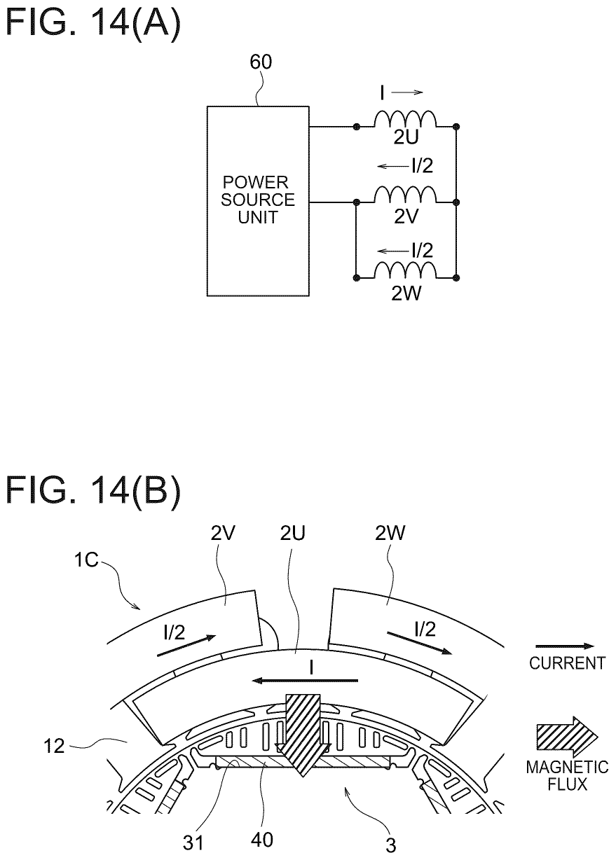

FIG. 14(A) is a diagram illustrating the connection state between the power source unit 60 of the magnetizing apparatus and the coils 2U, 2V, and 2W in Comparative Example. The permanent magnets 40 are magnetized in a state where the rotor 3 (FIG. 2) is incorporated inside the stator 1C.

During the magnetizing step, the coils 2V and 2W of the stator 1C are connected in parallel, and the coil 2U is connected to the coils 2V and 2W in series. Thus, when the magnetization current flows in the coil 2U is defined as I, the magnetization current flows in the coil 2V is I/2 and the magnetization current flows in the coil 2W is also I/2.

FIG. 14(B) is a diagram illustrating the flow of the magnetization current and the flow of the magnetizing flux in the magnetizing step of Comparative Example. In Comparative Example, the permanent magnet 40 is magnetized in a state where the permanent magnet 40 faces the coil 2U, that is, in a state where the center of the coil 2U in the circumferential direction faces the center of the permanent magnet 40 in the circumferential direction (the pole center).

As described above, the magnetization current I flows in the coil 2U, while the magnetization current I/2 flows in each of the coils 2V and 2W. A large amount of magnetic flux flows in the center part of the permanent magnet 40 facing the coil 2U. A relatively small amount of magnetic flux flows in each of the end parts of the permanent magnet 40 facing the coil 2V and 2W.

In Comparative Example, the permanent magnets 40 can be magnetized in a state where the rotor 3 (FIG. 2) is incorporated inside the stator 1C, and thus the productivity can be improved as compared to the case of using the magnetizing yoke 90 (FIG. 11(A)). However, the coils 2U, 2V, and 2W of the stator 1C are thinner than the coils 92 of the magnetizing yoke 90, and thus there is a possibility that the coils 2U, 2V, and 2W may be damaged due to the electromagnetic force generated by the magnetization current

### (Electromagnetic Force Generated by Magnetization Current)

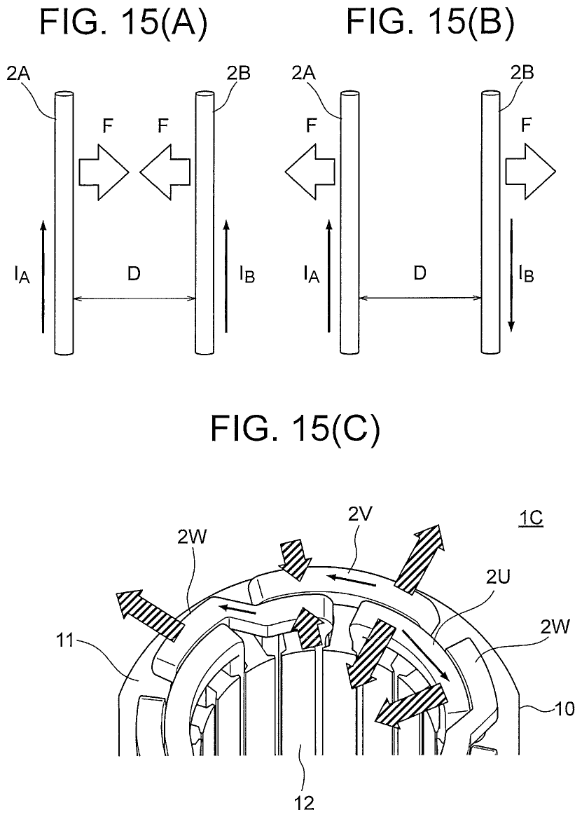

Next, the electromagnetic force generated in the coils 2 during the magnetizing step will be described. FIGS. 15(A) and 15(B) are schematic diagrams illustrating a generation principle of the electromagnetic force. In this example, two conductors 2A and 2B are arranged in parallel, and current I_{A} [A] flows through the conductor 2A while current I_{B} [A] flows through the conductor 2B. A distance between the conductors 2A and 2B is represented by D[m].

The electromagnetic force F per unit length [N/m] acts on the conductors 2A and 2B. The electromagnetic force F is the Lorentz force expressed by the following equation (1):

F=μ₀×I_{A}×I_{B}(2π×D) (1)
where μ₀ is a magnetic permeability of the vacuum, and μ₀=4π×10⁻⁷ [H/m].

When the current I_{A} and the current I_{B} flow in the same direction as illustrated in FIG. 15(A), the electromagnetic force F acts on the conductors 2A and 2B in the direction in which the conductors 2A and 2B are attracted to each other. On the other hand, when the current I_{A} and the current I_{B} flow in the opposite directions as illustrated in FIG. 15(B), the electromagnetic force F acts on the conductors 2A and 2B in the direction in which the conductors 2A and 2B are repelled from each other.

FIG. 15(C) is a schematic diagram illustrating electromagnetic forces acting on the coils 2U, 2V, and 2W (FIG. 12) in Comparative Example. In each of the area where the coil 2U faces the coil 2V and the area where the coil 2U faces the coil 2W, the currents flow in the opposite directions, so that large electromagnetic forces act on the coils 2U and 2W in the direction in which the coils 2U and 2W are repelled from each other. In an area where the coil 2V faces the coil 2W, the currents flow in the same direction, so that small electromagnetic forces act on the coils 2V and 2W in the direction in which the coils are attracted to each other.

Since these electromagnetic forces act on the coils 2 instantaneously in the magnetizing step, there is a possibility that the conductors of the coils 2 may be damaged or deformed, or that films covering the conductors may be damaged to cause insulation failure.

The above equation (1) shows that the electromagnetic force can be reduced by increasing the distance D between the conductors 2A and 2B illustrated in FIG. 15(A) or by decreasing the currents I_{A} and I_{B}. However, if the distance D between the conductors 2A and 2B is increased, an interval between the adjacent coils 2 increases. This leads to a decrease in the occupancy ratio of the coil 2 in the slot 13 or an increase in the circumference of the coil 2. Thus, increase in the distance D is not a practical choice. For this reason, the currents I_{A} and I_{B}, in other words, the magnetization currents that flow through the coils 2 are desired to be reduced to a lower level.

### (Magnetization Current)

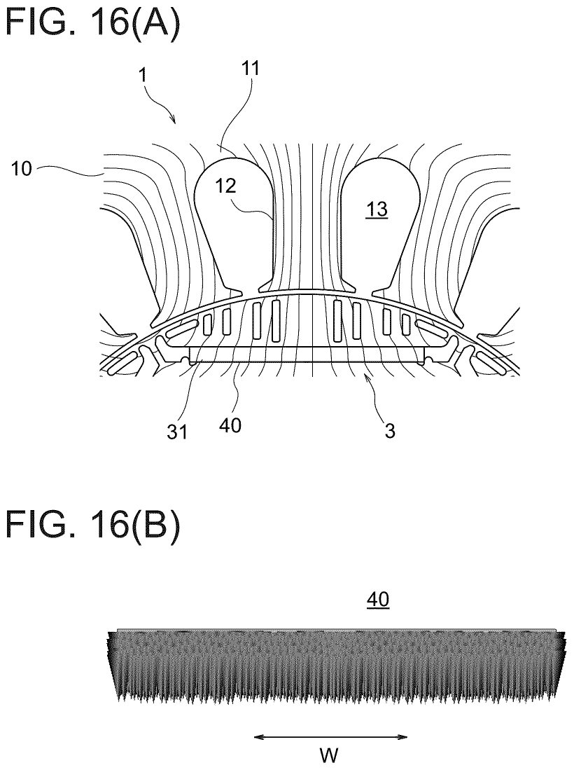

Next, the magnetization current required to magnetize the permanent magnet 40 in the first embodiment will be described by comparison with Comparative Example. FIG. 16(A) is a diagram illustrating the analysis result, which is obtained by a finite element method, of the magnetizing flux in the magnetizing step of Comparative Example described with reference to FIGS. 14(A) and 14(B). The magnetic flux density is high in an area where magnetic flux lines are densely distributed, and is low in an area where magnetic flux lines are sparsely distributed.

In Comparative Example, the permanent magnet 40 is magnetized in a state where the permanent magnet 40 faces the coil 2U as described with reference to FIG. 14(A). Thus, the permanent magnet 40 faces three teeth 12. The magnetizing flux from the tooth 12, which is the middle tooth of the three teeth 12, flows into the center part of the permanent magnet 40. The magnetizing flux from the teeth 12, which are located at both ends of the three teeth 12, flows into both end parts of the permanent magnet 40.

FIG. 16(B) is a diagram illustrating the analysis result, which is obtained by the finite element method, of the magnetization distribution of the permanent magnet 40. In FIG. 16(B), the direction of each arrow indicates the magnetization direction, and the length of each arrow indicates the strength of magnetization. The arrow W indicates the width direction of the permanent magnet 40. It is understood that the permanent magnet 40 is magnetized uniformly across its entire area in the width direction.

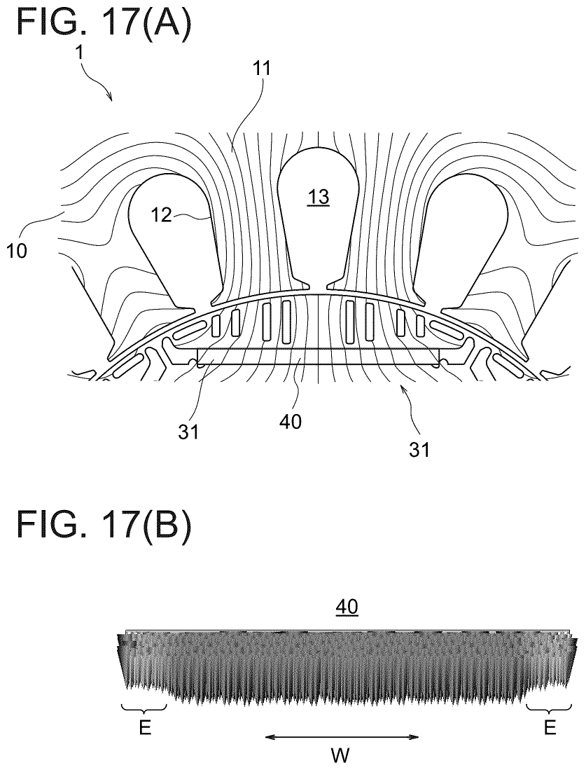

FIG. 17(A) is a diagram illustrating the analysis result, which is obtained by the finite element method, of the magnetizing flux in the motor 100 of the first embodiment when the rotor 3 is located at the reference position illustrated in FIG. 9(A) and the one-time magnetization is performed.

When the motor 100 of the first embodiment is located at the reference position, the slot 13 in which the coil 2W (FIG. 9(A)) in which no current flows is housed faces the center part of the permanent magnet 40. To this permanent magnet 40, the magnetizing flux flows from the teeth 12 on both sides of the slot 13.

FIG. 17(B) is a diagram illustrating the analysis result, which is obtained by the finite element method, of the magnetization distribution of the permanent magnet 40. The arrow W indicates the width direction of the permanent magnet 40. It is understood that that the center part of the permanent magnet 40 in the width direction is sufficiently magnetized, but the end parts of the permanent magnet 40 in the width direction (indicated by reference character E in FIG. 17(B)) are insufficiently magnetized.

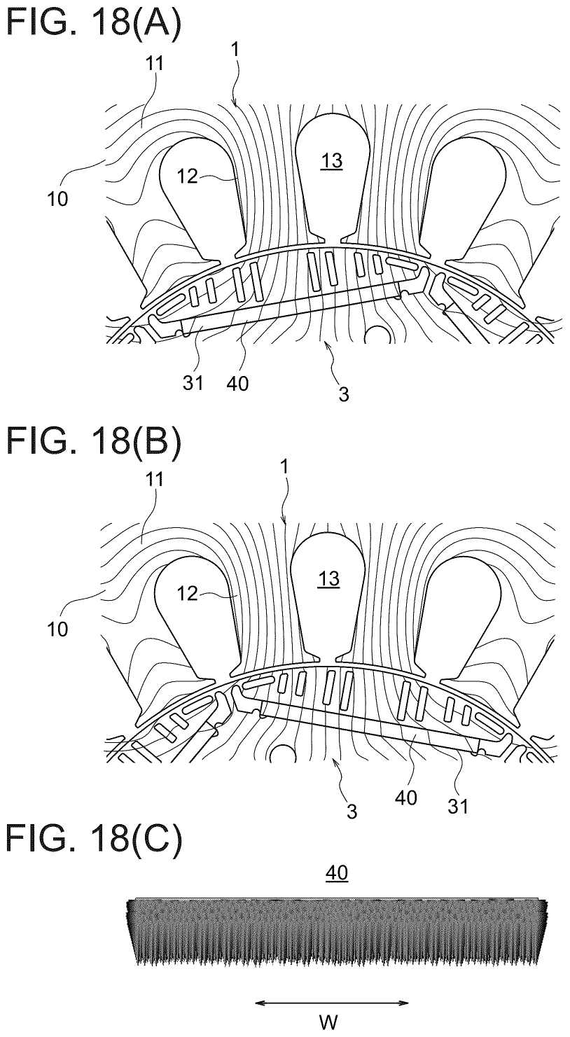

FIGS. 18(A) and 18(B) are diagrams illustrating the analysis results, which are obtained by the finite element method, of the magnetizing flux in the motor 100 of the first embodiment when the rotor 3 is located at the rotating positions illustrated in FIGS. 9(B) and 9(C) and the two-time magnetization is performed.

As illustrated in FIG. 18(A), in the first magnetizing step, the rotor 3 is located at a rotating position at which the rotor 3 is rotated by an angle θ counterclockwise with respect to the reference position. In this state, the magnetizing flux flows in the direction that is closer to being parallel to the easy magnetization direction of the permanent magnet 40 on one end side of the permanent magnet 40 (in this example, on the right side in the figure). Incidentally, the easy magnetization direction of the permanent magnet 40 is the thickness direction of the permanent magnet 40 as described above.

As illustrated in FIG. 18(B), in the second magnetizing step, the rotor 3 is located at a rotating position at which the rotor 3 is rotated by the angle θ clockwise with respect to the reference position. In this state, the magnetizing flux flows in the direction that is closer to being parallel to the easy magnetization direction of the permanent magnet 40 on the other end side of the permanent magnet 40 (in this example, on the left side in the figure).

As above, by performing the first magnetizing step and the second magnetizing step, the magnetization can be performed in such a manner that the direction of the magnetizing flux and the easy magnetization direction of the permanent magnet 40 are closer to being parallel to each other on both of one end side and the other end side of the permanent magnet 40.

FIG. 18(C) is a diagram illustrating the analysis result, which is obtained by the finite element method, of the magnetization distribution of the permanent magnet 40. The arrow W indicates the width direction of the permanent magnet 40. It is understood that the permanent magnet 40 is magnetized uniformly across its entire area in the width direction.

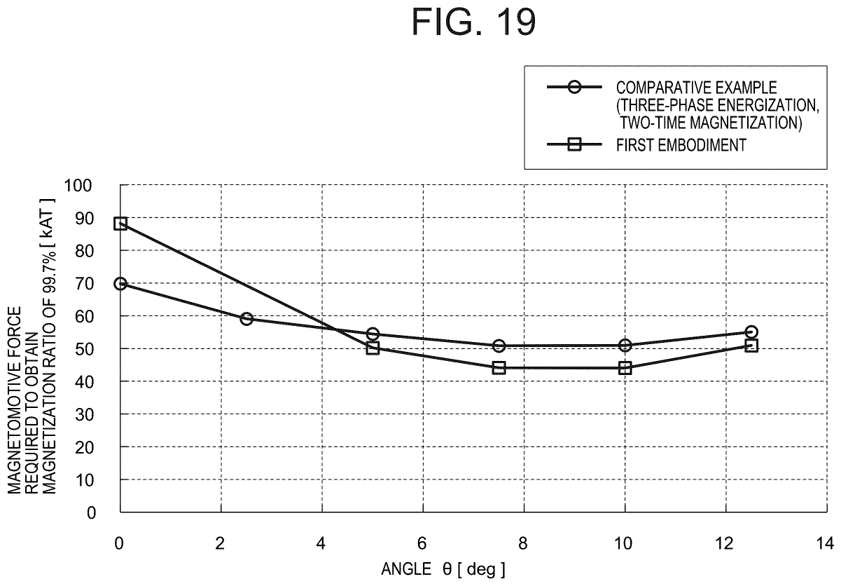

FIG. 19 is a graph showing the relationship between the angle θ in the first magnetizing step and the second magnetizing step and the magnetomotive force required to obtain a magnetization ratio of the permanent magnet 40 of 99.7[%]. The magnetizing ratio [%] indicates the degree of magnetization, assuming that perfect magnetization is 100 [%]. The magnetomotive force [kA·T] is the product of the current [kA] applied to the coil 2 and the number of turns [T] of the coil 2. In this example, the magnetomotive force is the product of the current [kA] applied to the U-phase coil 2U and the number of turns [T] of the coil 2U. Hereinafter, the magnetomotive force required to obtain a magnetization ratio of the permanent magnet 40 of 99.7[%] is referred to as a magnetization magnetomotive force.

In FIG. 19, data on the first embodiment is data in the case of using the motor 100 of the first embodiment and applying the magnetization current to the coils 2U and 2V as illustrated in FIG. 10(A) in a state where the rotor 3 is rotated by the angle θ in the first direction and in the second direction with respect to the reference position, i.e., performing the two-time magnetization using two-phase energization. Incidentally, data at angle θ=0 is data in the case of performing the one-time magnetization.

Data on Comparative Example is data in the case of incorporating the rotor 3 inside the stator 1C of Comparative Example (FIG. 12) and applying magnetization current to the coils 2U, 2V, and 2W as illustrated in FIG. 14(A) in a state where the rotor 3 is rotated by the angle θ in the first direction and in the second direction with respect to the reference position, i.e., performing the two-time magnetization using three-phase energization. Incidentally, data at angle θ=0 is data in the case of performing the one-time magnetization.

As can be seen from FIG. 19, in the case of performing the one-time magnetization (i.e., at angle θ=0), the magnetization magnetomotive force in the first embodiment is larger than the magnetization magnetomotive force in Comparative Example. However, as the angle θ increases, the magnetization magnetomotive force in the first embodiment decreases. When the angle θ is five degrees or more, the magnetization magnetomotive force in the first embodiment is lower than the magnetization magnetomotive force in comparative Example.

The magnetization magnetomotive force in Comparative Example is the smallest at the angle θ of 7.5 degrees and is 50.8 kAT. In contrast, the magnetization magnetomotive force in the first embodiment is the smallest at the angle θ of 10 degrees and is 44.1 kAT. That is, in the first embodiment, the magnetization magnetomotive force decreases by 13.2%, as compared to Comparative Example.

When the magnetization magnetomotive force decreases by 13.2%, it means that the magnetization current decreases by 13.2%. As described above, the electromagnetic force acting between the coils 2 is proportional to the square of the magnetization current. When the magnetization current decreases by 13.2%, the electromagnetic force acting between the coils 2 decreases by 24.7% because of (100−13.2)²=75.3.

### (Electromagnetic Force Generated in Magnetizing Step)

Next, the analysis results of the electromagnetic forces generated in the coils 2U, 2V, and 2W due to the magnetization current for magnetizing the permanent magnets 40 will be described. The electromagnetic force is the electromagnetic force described with reference to FIGS. 15(A) and 15(B), i.e., the Lorentz force.

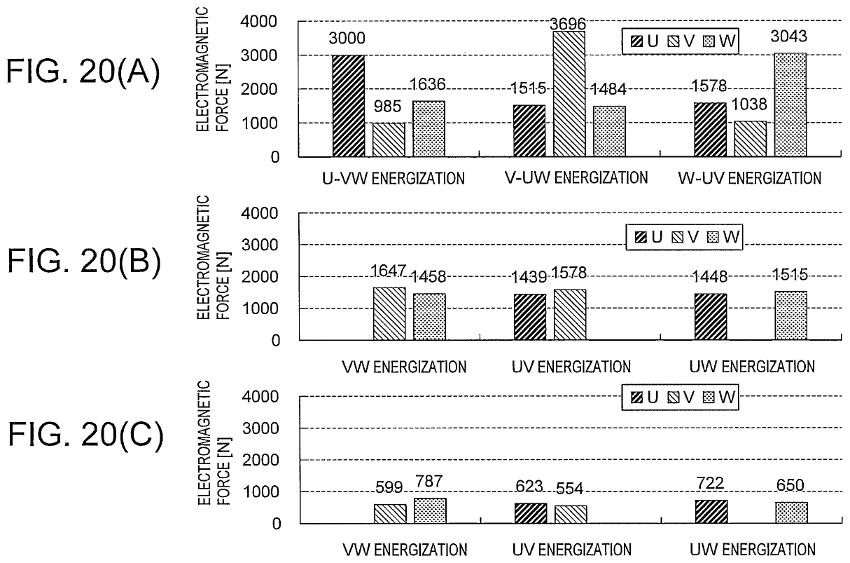

FIG. 20(A) shows the analysis results of the electromagnetic forces generated in the case of incorporating the rotor 3 inside the stator 1C of Comparative Example (FIG. 12), and applying the magnetization current to the coils 2U, 2V, and 2W of the three phases in a state where the rotor 3 is located at the reference position, i.e., performing the one-time magnetization using three-phase energization. In this example, the magnetomotive force required to obtain a magnetization ratio of 99.7 is 69.8 kAT.

In the horizontal axis of FIG. 20(A), U-VW energization represents a case where the coils 2V and 2W are connected in parallel with each other and are connected in series with the coil 2U (FIG. 14(A)). Similarly, the V-UW energization represents a case where the coils 2U and 2W are connected in parallel with each other and are connected in series with the coil 2V. The W-UV energization represents a case where the coils 2U and 2V are connected in parallel with each other and are connected in series with the coil 2W. The vertical axis represents the electromagnetic forces generated in the coils 2U, 2V, and 2W.

When the coils 2V and 2W are connected in parallel with each other and are connected in series with the coil 2U, the magnetization current I flows in the coil 2U, while the magnetization current I/2 flows in each of the coils 2V and 2W (see FIG. 14(A)). In this case, the electromagnetic force generated in the coil 2U is the largest and is 3000 N.

Similarly, when the coils 2U and 2W are connected in parallel with each other and are connected in series with the coil 2V, the electromagnetic force generated in the coil 2V is the largest and is 3696 N. When the coils 2U and 2V are connected in parallel with each oher and are connected in series with the coil 2W, the electromagnetic force generated in the coil 2W is the largest and is 3043 N.

FIG. 20(B) shows the analysis results of the electromagnetic forces generated in the case of incorporating the rotor 3 inside the stator 1C of Comparative Example (FIG. 12), and applying the magnetization current to two of the coils 2U, 2V, and 2W in a state where the rotor 3 is rotated by the angle θ in the first direction and in the second direction with respect to the reference position, i.e., performing two-time magnetization using two-phase energization. In this example, the magnetomotive force required to obtain a magnetization ratio of 99.7 is 44.1 kAT.

In the horizontal axis of FIG. 20(B), the VW energization represents a case where the coil 2U is opened and the coils 2V and 2W are connected in series. Similarly, the UV energization represents a case where the coil 2W is opened and the coils 2U and 2V are connected in series (FIG. 10(A)). The UW energization represents to a case where the coil 2V is opened and the coils 2U and 2W are connected in series. The vertical axis represents the electromagnetic forces generated in the coils 2U, 2V, and 2W.

When the coil 2U is opened and the coils 2V and 2W are connected in series, the electromagnetic force generated in the coil 2V is the largest and is 1647 N. This value is 45.1% less than the electromagnetic force of 3000 N in the U-VW energization of FIG. 20(A).

Similarly, when the coil 2W is opened and the coils 2U and 2V are connected in series, the electromagnetic force generated in the coil 2V is the largest and is 1578 N. When the coil 2V is opened and the coils 2U and 2W are connected in series, the electromagnetic force generated in the coil 2W is the largest and is 1515 N. In either case, as compared to the case where the one-time magnetization is performed using the three-phase energization (FIG. 20(A)), the magnetization magnetomotive force decreases significantly.

FIG. 20(C) shows the analysis results of the electromagnetic forces generated in the case of applying the magnetization current to two of the coils 2U, 2V, and 2W in the motor 100 of the first embodiment in a state where the rotor 3 is rotated by the angle θ in the first direction and in the second direction with respect to the reference position, i.e., performing the two-time magnetization using two-phase energization. In this example, the magnetomotive force required to obtain a magnetization ratio of 99.7 is 44.1 kAT.

In the horizontal axis of FIG. 20(C), the VW energization represents a case where the coil 2U is opened and the coils 2V and 2W are connected in series. Similarly, the UV energization represents a case where the coil 2W is opened and the coils 2U and 2V are connected in series (FIG. 10(A)). The UW energization refers to a case where the coil 2V is opened and the coils 2U and 2W are connected in series. The vertical axis represents the electromagnetic forces generated in the coils 2U, 2V, and 2W.

When the coil 2U is opened and the coils 2V and 2W are connected in series, the electromagnetic force generated in the coil 2W is the largest and is 787 N. This value is 52.2% less than the electromagnetic force of 1647 N in the VW energization of FIG. 20(B).

Similarly, when the coil 2W is opened and the coils 2U and 2V are connected in series, the electromagnetic force generated in the coil 2V is the largest and is 623 N. When the coil 2V is opened and the coils 2U and 2W are connected in series, the electromagnetic force generated in the coil 2U is the largest and is 722 N. In either case, as compared to Comparative Examples (FIGS. 20(A) and 20(B)), the magnetization magnetomotive force decreases significantly.

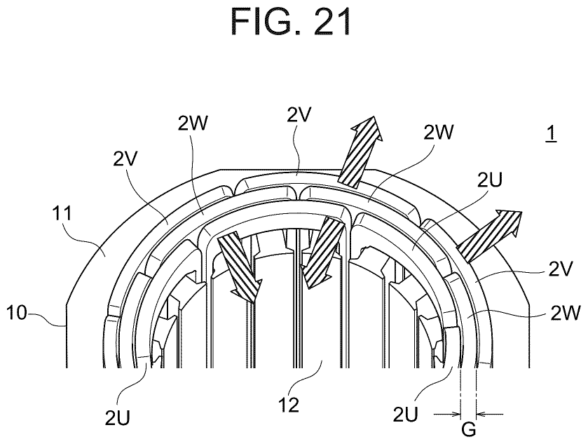

FIG. 21 is a schematic diagram illustrating electromagnetic forces acting on the coils 2U, 2V, and 2W in the first embodiment. In FIG. 20(C) described above, when the coil 2W is opened and the coils 2U and 2V are connected in series, the maximum electromagnetic force is 623 N. This is smaller than that when the coil 2U is opened and the coils 2V and 2W are connected in series or when the coil 2V is opened and the coils 2U and 2W are connected in series.

As described with reference to FIG. 5, the coil end 22W of the coil 2W is located between the coil ends 22U and 22V of the coils 2U and 2V, and therefore the coil ends 22U and 22V are distanced from each other. Thus, when the current is applied to the coils 2U and 2V and is not applied to the coil 2W, the electromagnetic force generated between the coil ends 22U and 22V can be made smaller because of a wide interval between the coil ends 22U and 22V (denoted by reference character G in FIG. 21) in which the current flows.

In contrast, when the current is applied to the coils 2U and 2W, or when the current is applied to the coils 2V and 2W, the electromagnetic force generated increases because of a narrow interval between the coil ends 22U and 22W or between the coil ends 22V and 22W.

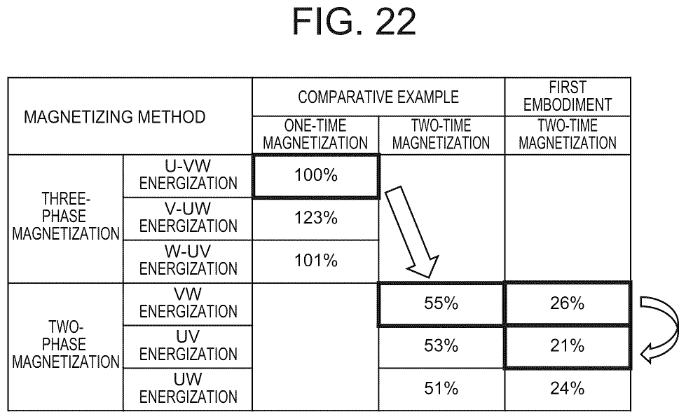

FIG. 22 is a table showing relative values of the magnetization magnetomotive forces illustrated in FIGS. 20(A) to 20(C) with respect to the value in the U-VW energization (3000 N) illustrated in FIG. 20(A).

As shown in FIG. 22, as compared to the magnetization magnetomotive force (100%) in the U-VW energization when the rotor 3 is incorporated inside the stator 1C of Comparative Example and the one-time magnetization is performed using the three-phase energization, the magnetization magnetomotive force in the VW energization when the two-time magnetization is performed using the two-phase magnetization is reduced to 55%. Further, when the two-time magnetization is performed using the two-phase energization in the motor of the first embodiment, the magnetization magnetomotive force in the VW energization is reduced to 26%. Furthermore, the magnetization magnetomotive force in the UV energization is reduced to 21%.

In the first embodiment, as described with reference to FIG. 4, the number of winding portions 20U, 20V, 20W of each phase coil 2U, 2V, 2W is the same as the number of poles. In one slot 13, two coil sides 21 of the same phase coil are inserted. Thus, the cross-sectional area of each coil of the coils 2U, 2V, and 2W is half that of Comparative Example.

Therefore, when the magnetization magnetomotive force in the first embodiment is reduced to 21% of Comparative Example (three-phase energization, one-time magnetization), the stress caused in the coils 2 by the electromagnetic force due to the magnetization current is reduced to 42%, which equals to 21%×2, as compared to Comparative Example. As a result, the stress caused in the coils 2 due to the magnetization current is 58% less than that in Comparative Example.

### (Constituent Material of Permanent Magnet)

Next, the constituent material of the permanent magnet 40 of the first embodiment will be described. The permanent magnet 40 is composed of a neodymium rare earth magnet containing iron, neodymium, and boron. Dysprosium is desirably added to the neodymium rare earth magnet so as to increase its coercive force. However, a large dysprosium content leads to an increase in the manufacturing cost. Thus, in order to reduce the manufacturing cost, it is desirable to set the dysprosium content at 4% by weight or less.

In general, when the dysprosium content in the neodymium rare earth magnet is decreased, the coercive force of the neodymium rare earth magnet is reduced. Thus, the permanent magnet 40 has a sufficient thickness so as to suppress demagnetization due to a small dysprosium content. On the other hand, as the thickness of the permanent magnet 40 increases, the permanent magnet 40 is less likely to be magnetized, and thus the current required to magnetize the permanent magnet 40 increases.

In the first embodiment, the magnetization can be performed while making the direction of the magnetizing flux and the easy magnetization direction of the permanent magnet 40 closer to being parallel to each other on both of one end side and the other end side of the permanent magnet 40 in the width direction (see FIGS. 18(A) and 18(B)). Thus, even when the dysprosium content in the permanent magnet 40 is 4% by weight or less, the magnetization current required to magnetize the permanent magnet 40 can be reduced.

In order to suppress the reduction in the coercive force associated with the reduction of the dysprosium content in the permanent magnet 40, it is desirable to perform diffusion treatment with dysprosium. However, if the diffusion treatment with dysprosium is performed, the magnetizability decreases, and the current required for the magnetization increases.

In the first embodiment, the magnetization can be performed while making the direction of the magnetizing flux and the easy magnetization direction of the permanent magnet 40 closer to being parallel to each other on both of one end side and the other end side of the permanent magnet 40. Thus, the magnetization current required for the magnetization of the permanent magnet 40 can be suppressed to a lower level even in the rotor subjected to the diffusion treatment with dysprosium for suppressing the reduction in the coercive force.

Instead of dysprosium, terbium may be added to the permanent magnet 40. Since a large terbium content leads to an increase in the manufacturing cost, the terbium content is desirably 4% by weight or less. In order to suppress the reduction in the coercive force associated with the reduction of the terbium content, it is desirable to perform diffusion treatment with terbium.

Also in this case, the magnetization current is increased by increasing the thickness of the permanent magnet 40 and performing diffusion treatment with terbium, as explained for dysprosium. However, in the first embodiment, the magnetization can be performed while making the direction of the magnetizing flux and the easy magnetization direction of the permanent magnet 40 closer to being parallel to each other on both of one end side and the other end side of the permanent magnet 40, and thus the magnetization current can be suppressed to a lower level.

### Effects of Embodiment

As described above, in the first embodiment, the rotor 3 having the P magnetic poles and the stator 1 having the three-phase coils 2U, 2V, and 2W are provided. The three-phase coils 2U, 2V and 2W include the first phase (U-phase) coil 2U disposed on the innermost side in the radial direction, the second phase (V-phase) coil 2V disposed on the outermost side in the radial direction, and the third phase (W-phase) coil 2W disposed between the coils 2U and 2V in the radial direction. The coils 2U, 2V, and 2W have the P winding portions 20U, 20V, and 20W, respectively. Adjacent two winding portions of these winding portions 20U, 20V, and 20W are inserted into one slot 13 and extend in both directions in the circumferential direction from the one slot 13. The permanent magnet 40 is magnetized by the first magnetizing step performed in a state where the rotor 3 is rotated by the angle θ in the first direction with respect to the reference position, and the second magnetizing step performed in a state where the rotor 3 is rotated by the angle θ in the second direction with respect to the reference position. In each of the first magnetizing step and the second magnetizing step, the coil 2W is opened, the coil 2U and the coil 2V are connected in series, and the magnetization current is applied to the coils 2U and 2V.

As above, the coils 2U and 2V are connected in series and the magnetization current is applied thereto, while no magnetization current is applied to the coil 2W between the coils 2U and 2V. Thus, the electromagnetic force generated in the coils 2U, 2V, and 2W due to the magnetization current can be reduced, and thus the damage to the coils 2U, 2V, and 2W can be suppressed. By performing the first magnetizing step and the second magnetizing step, it is possible to make the direction of the magnetizing flux and the easy magnetization direction of the permanent magnet 40 closer to being parallel to each other on both of one end side and the other end side of the permanent magnet 40. Accordingly, the permanent magnet 40 can be magnetized uniformly.

Since the winding factor is 1 and each coil 2 is arranged dispersedly over the winding portions 20, the number of which is the same number as the number of poles P, the magnetic flux of the permanent magnet 40 can be used effectively, and the average circumference of each coil 2 can be shortened. Thus, the winding resistance can be reduced, and copper loss can be reduced.

Since the permanent magnet 40 can be magnetized uniformly, the magnetization current can be reduced to a lower level even when the dysprosium content or terbium content in the permanent magnet 40 is restrained to a small level.

### Second Embodiment

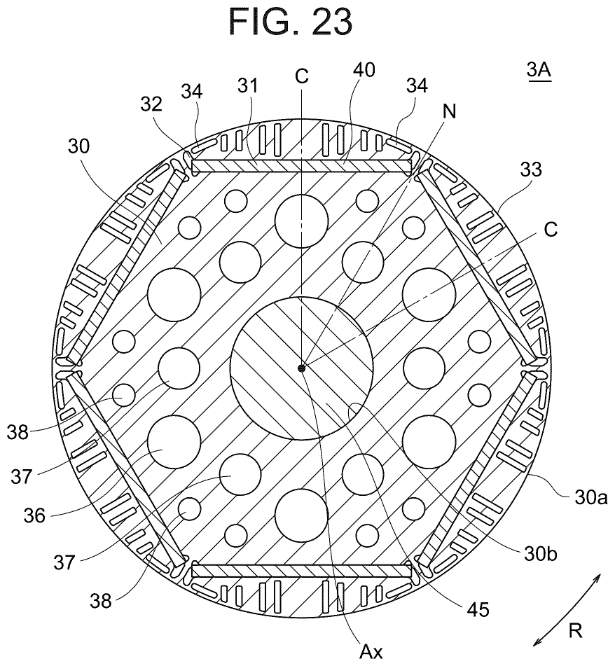

Next, a second embodiment will be described. FIG. 23 is a cross-sectional view illustrating a rotor 3A of a motor of the second embodiment. The motor of the second embodiment differs from the motor 100 of the first embodiment in the magnet insertion hole 31 and the permanent magnet 40 of the rotor 3A.

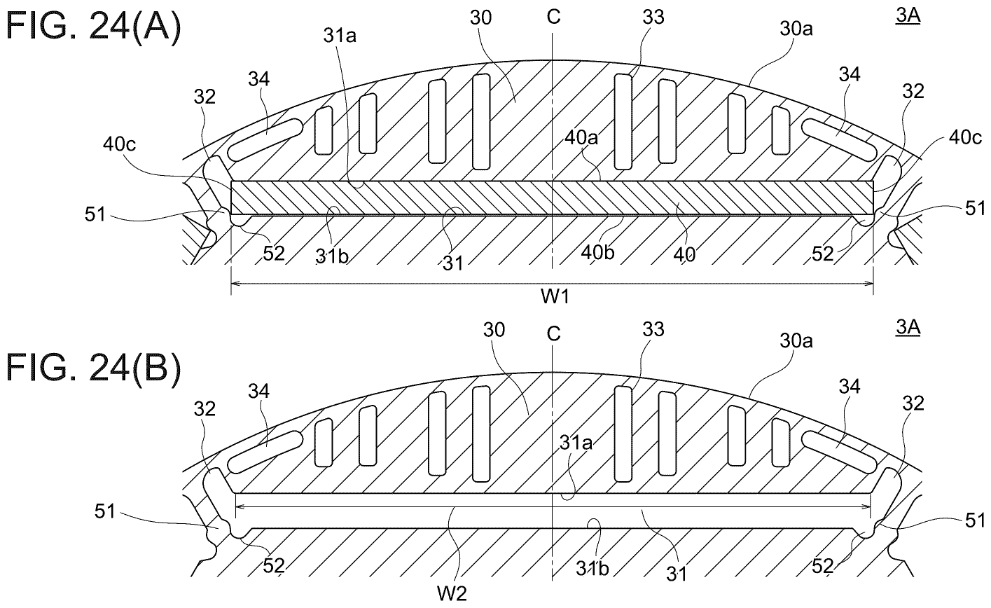

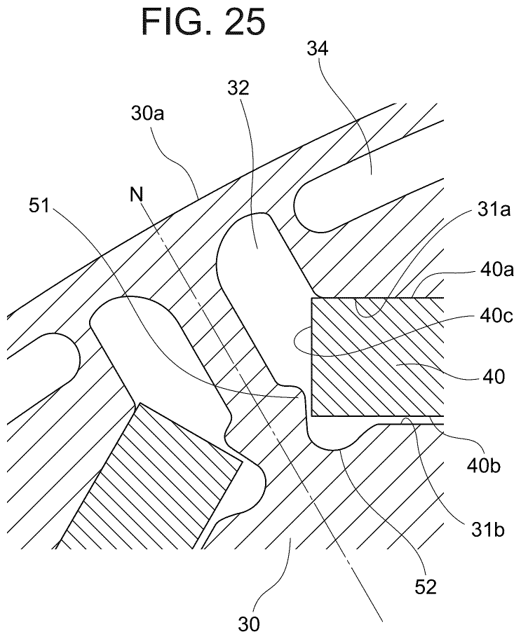

FIG. 24(A) is an enlarged cross-sectional view illustrating the magnet insertion hole 31, the permanent magnet 40, and their surroundings in the rotor 3A. FIG. 24(B) is an enlarged cross-sectional view illustrating the magnet insertion hole 31 and its surroundings in the rotor core 30 of the rotor 3A.

As illustrated in FIG. 24(A), the permanent magnet 40 has a magnetic pole surface 40a located on the outer side in the radial direction, a back surface 40b located on the inner side in the radial direction, and side end surfaces 40c located on both sides in the circumferential direction. Both of the magnetic pole surface 40a and the back surface 40b are surfaces perpendicular to the pole center line C. The thickness of the permanent magnet 40 is an interval between the magnetic pole surface 40a and the back surface 40b, and is, for example, 2.0 mm.

The magnet insertion hole 31 extends linearly in a direction perpendicular to the pole centerline C. The magnet insertion hole 31 has an outer edge 31a located on the outer side in the radial direction and an inner edge 31b located on the inner side in the radial direction. The outer edge 31a of the magnet insertion hole 31 faces the magnetic pole surface 40a of the permanent magnet 40, while the inner edge 31b of the magnet insertion hole 31 faces the back surface 40b of the permanent magnet 40.

Flux barriers 32 are formed on both sides of the magnet insertion hole 31 in the circumferential direction. Each flux barrier 32 is an opening extending in the radial direction from an end of the magnet insertion hole 31 in the circumferential direction toward the outer circumference of the rotor core 30. The flux barrier 32 is provided to suppress the leakage of magnetic flux between the adjacent magnetic poles.

Protrusions 51 that contact the side end surfaces 40c of the permanent magnet 40 are formed on both sides in the circumferential direction of the inner edge 31b of the magnet insertion hole 31. Each protrusion 51 is formed at abase portion of the flux barrier 32 on the magnet insertion hole 31 side. The protrusion 51 of the magnet insertion hole 31 restricts the position of the permanent magnet 40 within the magnet insertion hole 31.

A semicircular groove 52 is formed between the inner edge 31b and the protrusion 51 of the magnet insertion hole 31. The groove 52 serves to prevent rounding of the corner between the inner edge 31b and the protrusion 51 during a punching process of the electromagnetic steel sheet.

As illustrated in FIG. 24(A), the width of the permanent magnet 40 in a direction perpendicular to the pole center line C is defined as a width W1. The width W1 is an interval between the side end surfaces 40c of the permanent magnet 40. As illustrated in FIG. 24(B), the width of the outer edge 31a of the magnet insertion hole 31 in the direction perpendicular to the pole center line C is defined as a width W2.

The width W1 of the permanent magnet 40 and the width W2 of the magnet insertion hole 31 satisfy W1>W2. In this example, the width W1 of the permanent magnet 40 is 39 mm, and the width W2 of the magnet insertion hole 31 is 38.4 mm.

As the width W1 of the permanent magnet 40 increases, the magnetic flux interlinked with the coils 2 of the stator 1 increases, and thus the output of the motor can be improved. Alternatively, instead of improving the output of the motor, the current value of the current applied to the coil 2 can be decreased to thereby reduce copper loss.

FIG. 25 is an enlarged diagram illustrating the ends of the magnet insertion holes 31 and their surroundings. As illustrated in FIG. 25, the end part of the permanent magnet 40 in the width direction protrudes outward from the outer edge 31a of the magnet insertion hole 31 and is located within the flux barrier 32.

The magnetizing method of the permanent magnet 40 is as described in the first embodiment That is, as illustrated in FIG. 10(A), the coil 2W of the coils 2U, 2V, and 2W is opened, the coils 2U and 2V are connected in series, and the magnetization current is applied to the coils 2U and 2V. As described with reference to FIGS. 9(B) and 9(C), the first magnetizing step and the second magnetizing step are performed by rotating the rotor 3A by the angle θ in the first direction and in the second direction with respect to the reference position.

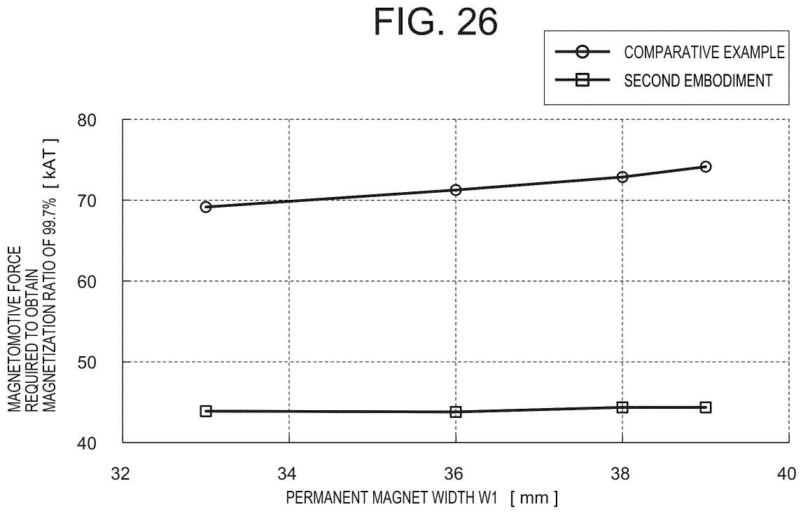

FIG. 26 is a diagram showing the relationship between the width W1 of the permanent magnet 40 and the magnetomotive force (the magnetization magnetomotive force) required to obtain a magnetization ratio of 99.7%. FIG. 26 shows data in a case where the rotor 3A of the second embodiment is incorporated inside the stator 1 of FIG. 4 and the two-time magnetization is performed using the two-phase energization described in the first embodiment FIG. 26 also shows data in a case where the rotor 3A is incorporated inside the stator 1C of Comparative Example (FIG. 12), and the one-time magnetization is performed using the three-phase energization.

In the case where the rotor 3A is incorporated inside the stator 1C of Comparative Example (FIG. 12) and the one-time magnetization is performed using the three-phase energization, the magnetization magnetomotive force increases as the width of the permanent magnet 40 increases. This is because the end part of the permanent magnet 40 in the width direction protrudes outward from the outer edge 31a of the magnet insertion hole 31, and thus the magnetizing flux is less likely to reach the end part of the permanent magnet 40.

In contrast, in the case where the rotor 3A of the second embodiment is incorporated inside the stator 1 of FIG. 4 and the two-time magnetization is performed using the two-phase energization, the magnetization magnetomotive force does not appear to increase even when the width of the permanent magnet 40 increases. This is because the first magnetizing step and the second magnetizing step are performed by rotating the rotor 3A by the angle θ in the first direction and in the second direction with respect to the reference position, and thus the magnetizing flux is more likely to reach the end parts of the permanent magnet 40 in the width direction even when the width W1 of the permanent magnet 40 increases.

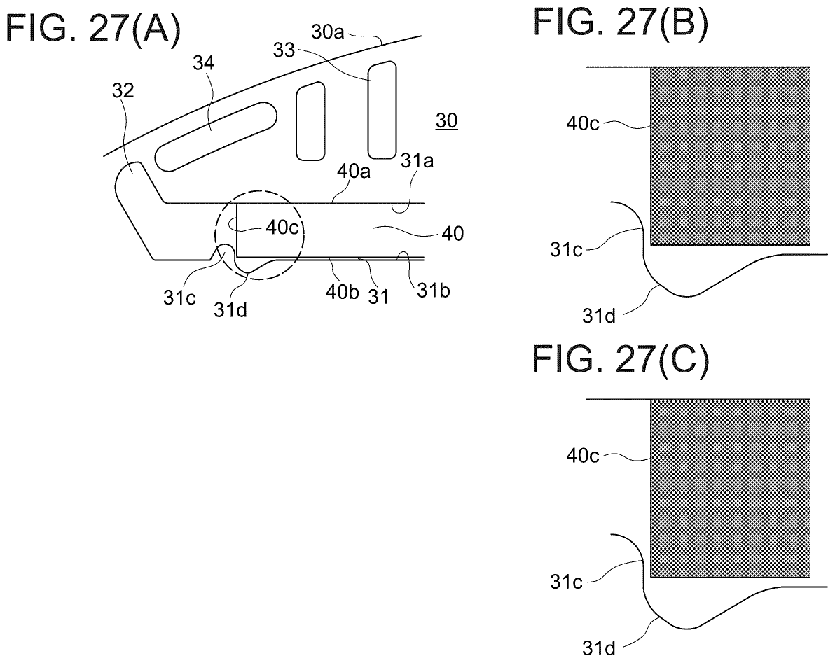

FIG. 27(A) is an enlarged diagram illustrating the end part of the permanent magnet 40 and its surroundings in the rotor 3 of the first embodiment. As illustrated in FIG. 27(A), in the rotor 3 of the first embodiment, the width of the permanent magnet 40 is 33 mm, and the width of the outer edge 31a of the magnet insertion hole 31 is 38.4 mm. Thus, the width of the permanent magnet 40 is shorter than the width of the magnet insertion hole 31. Thus, the end part of the permanent magnet 40 in the width direction does not protrude from the outer edge 31a of the magnet insertion hole 31.

FIG. 27(B) is a schematic diagram illustrating the analysis result of the magnetization distribution at the end part of the permanent magnet 40 (a part enclosed by a circle A in FIG. 27(A)) in a case where the rotor 3 of the first embodiment is incorporated inside the stator 1C (FIG. 12) of Comparative Example and the one-time magnetization is performed using the three-phase energization.

FIG. 27(C) is a schematic diagram illustrating the analysis result of the magnetization distribution at the end part of the permanent magnet 40 (the part enclosed by the circle A in FIG. 27(A)) in a case where the rotor 3 of the first embodiment is incorporated inside the stator 1 of FIG. 4 and the two-time magnetization is performed using the two-phase energization.

As illustrated in FIGS. 27(B) and 27(C), in the case of using either magnetizing method, magnetization is performed uniformly up to the end part of the permanent magnet 40 in the width direction, and a magnetization ratio of the permanent magnet 40 is 99.7%. This is because the end part of the permanent magnet 40 in the width direction does not protrude outward from the outer edge 31a of the magnet insertion hole 31, and the magnetizing flux is more likely to reach the end part of the permanent magnet 40.

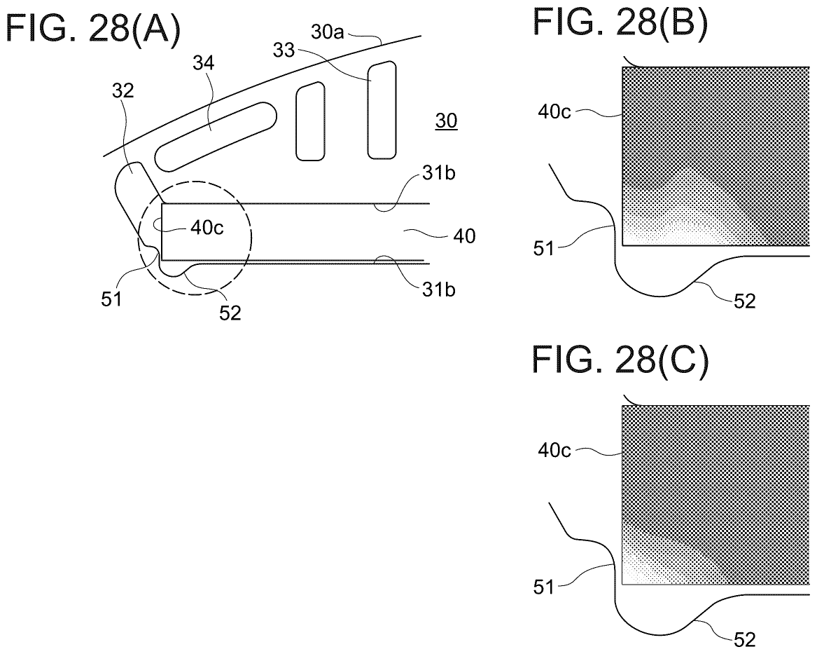

FIG. 28(A) is an enlarged diagram illustrating the end part of the permanent magnet 40 and its surroundings in the rotor 3A of the second embodiment. As illustrated in FIG. 28(A), in the rotor 3A of the second embodiment, the width of the permanent magnet 40 is 39 mm, and the width of the outer edge 31a of the magnet insertion holes 31 is 38.4 mm. Thus, the width of the permanent magnet 40 is longer than the width of the magnet insertion hole 31. Therefore, the end part of the permanent magnet 40 in the width direction protrudes from the outer edge 31a of the magnet insertion hole 31.

FIG. 28(B) is a schematic diagram illustrating the analysis result of the magnetization distribution at the end part of the permanent magnet 40 (a part enclosed by a circle A in FIG. 28(A)) in a case where the rotor 3A of the second embodiment is incorporated inside the stator 1C (FIG. 12) of Comparative Example and the one-time magnetization is performed using the three-phase energization.

As illustrated in FIG. 28(B), when the one-time magnetization is performed using the three-phase energization, an area not sufficiently magnetized is created at the corner of the end part of the permanent magnet 40 on the inner circumferential side. The magnetization ratio of the permanent magnet 40 is 99.5%.

FIG. 28(C) is a schematic diagram illustrating the magnetization distribution at the end part of the permanent magnet 40 (the part enclosed by the circle A in FIG. 28(A)) in a case where the rotor 3A of the second embodiment is incorporated inside the stator 1 of FIG. 4 and the two-time magnetization is performed using the two-phase energization.

As illustrated in FIG. 28(C), when the two-time magnetization is performed, an area not sufficiently magnetized at the end part of the permanent magnet 40 is reduced. The magnetization ratio of the permanent magnet 40 is 99.7%. That is, by performing the two-time magnetization, the magnetizing flux is more likely to reach the end part of the permanent magnet 40, and as a result, the permanent magnet 40 having a large width can be imparted with excellent magnetizing properties.

As described above, in the second embodiment, since the width W1 of the permanent magnet 40 is longer than the width W2 of the outer edge 31a of the magnet insertion hole 31 (W1>W2), the magnetic flux interlinked with the coil 2 of the stator 1 increases, so that the output of the motor can be improved. Alternatively, instead of improving the output of the motor, the current value of the current applied to the coil 2 can be decreased, so that copper loss can also be reduced.

The two-time magnetization is performed while changing the rotating position of the rotor 3A, so that the permanent magnet 40 can be sufficiently magnetized up to its ends in the width direction even when the width W1 of the permanent magnet 40 is set wide, and thus excellent magnetizing properties can be obtained.

In the first and second embodiments, the magnet insertion hole 31 extends linearly in the direction perpendicular to the pole center line C, but the magnet insertion hole 31 may extend in a V shape so as to be convex toward its inner side in the radial direction. Two or more permanent magnets may be disposed in each magnet insertion hole 31. Also in this case, one magnet insertion hole 31 corresponds to one magnetic pole.

In the first and second embodiments, the coil 2U is disposed on the innermost side in the radial direction, the coil 2V is disposed on the outermost side in the radial direction, and the coil 2W is disposed between the coils 2U and 2V. However, positions of the first phase, second phase, and third phase coils are not limited to these positions. It is sufficient that the first phase, second phase, and third phase coils are disposed in different positions in the radial direction.

### (Compressor)

Next, a compressor 300 to which the motor of each embodiment described above is applicable will be described. FIG. 29 is a cross-sectional view illustrating the compressor 300. The compressor 300 is the compressor 8 illustrated in FIG. 6. The compressor 300 is a scroll compressor in this example, but is not limited thereto.

The compressor 300 includes a shell 307, a compression mechanism 305 disposed in the shell 307, the motor 100 that drives the compression mechanism 305, a shaft 45 that connects the compression mechanism 305 and the motor 100, and a subframe 308 that supports a lower end of the shaft 45.

The compression mechanism 305 includes a fixed scroll 301 having a spiral portion, a swing scroll 302 having a spiral portion forming a compression chamber between the spiral portions of the fixed scroll 301 and the swing scroll 302, a compliance frame 303 that holds an upper end of the shaft 45, and a guide fame 304 that is fixed to the shell 307 to hold the compliance frame 303.

A suction pipe 310 that penetrates the shell 307 is press-fitted into the fixed scroll 301. The shell 307 is provided with a discharge pipe 311 through which a high-pressure refrigerant gas discharged from the fixed scroll 301 is discharged to the outside. The discharge pipe 311 communicates with a not-shown opening provided between the compression mechanism 305 of the shell 307 and the motor 100.

The motor 100 is fixed to the shell 307 by fitting the stator 1 into the shell 307. The configuration of the motor 100 has been described above. A glass terminal 309 for applying electric power to the motor 100 is fixed to the shell 307 by welding. The wires L1 and L2 illustrated in FIG. 6 are connected to the glass terminal 309 as a terminal portion.

When the motor 100 rotates, its rotation is transmitted to the swing scroll 302, causing the swing scroll 302 to swing. As the swing scroll 302 swings, the volume of the compression chamber formed by the spiral portion of the swing scroll 302 and the spiral portion of the fixed scroll 301 changes. Then, the refrigerant gas is sucked through the suction pipe 310, compressed, and discharged through the discharge pipe 311.

The motor 100 of the compressor 300 has high reliability because of its suppression of damage to the coils 2. Thus, the reliability of the compressor 300 can be improved.

### (Refrigeration Cycle Apparatus)

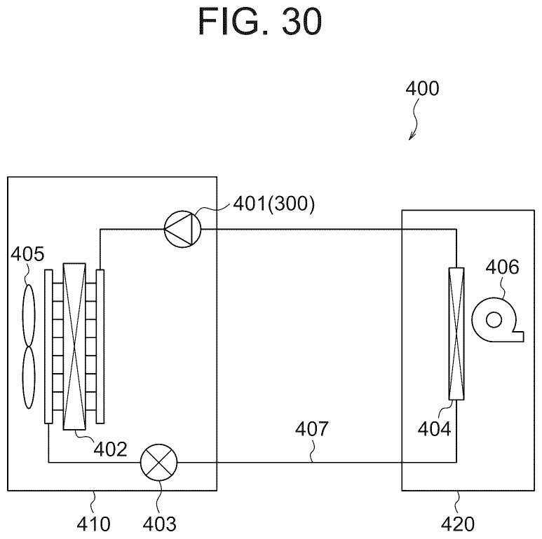

Next, a refrigeration cycle apparatus 400 having the compressor 300 illustrated in FIG. 29 will be described. FIG. 30 is a diagram illustrating the refrigeration cycle apparatus 400. The refrigeration cycle apparatus 400 is, for example, an air conditioner, but is not limited thereto.

The refrigeration cycle apparatus 400 illustrated in FIG. 30 includes a compressor 401, a condenser 402 to condense a refrigerant, a decompressor 403 to decompress the refrigerant, and an evaporator 404 to evaporate the refrigerant. The compressor 401, the condenser 402, and the decompressor 403 are provided in an indoor unit 410, while the evaporator 404 is provided in an outdoor unit 420.

The compressor 401, the condenser 402, the decompressor 403, and the evaporator 404 are connected together by a refrigerant pipe 407 to constitute a refrigerant circuit. The compressor 401 is constituted by of the compressor 300 illustrated in FIG. 29. The refrigeration cycle apparatus 400 includes an outdoor fan 405 facing the condenser 402 and an indoor fan 406 facing the evaporator 404.

The operation of the refrigeration cycle apparatus 400 is as follows. The compressor 401 compresses the sucked refrigerant and discharges the compressed refrigerant as a high-temperature and high-pressure refrigerant gas. The condenser 402 exchanges heat between the refrigerant discharged from the compressor 401 and the outdoor air fed by the outdoor fan 405 to condense the refrigerant and discharges the condensed refrigerant as a liquid refrigerant. The decompressor 403 expands the liquid refrigerant discharged from the condenser 402 and then discharges the liquid refrigerant as a low-temperature and low-pressure liquid refrigerant.

The evaporator 404 exchanges heat between the low-temperature and low-pressure liquid refrigerant discharged from the decompressor 403 and the indoor air to evaporate (vaporize) the refrigerant and then discharges the evaporated refrigerant as the refrigerant gas. Thus, the air from which heat is taken in the evaporator 404 is supplied by the indoor fan 406 to the interior of a room, which is a space to be air-conditioned.

The motor 100 described in each embodiment is applicable to the compressor 401 in the refrigeration cycle apparatus 400. Since the motor 100 has high reliability because of its suppression of the damage to the coils 2, the reliability of the refrigeration cycle apparatus 400 can be improved.

The desirable embodiments have been specifically described above, but the present disclosure is not limited to the above embodiments and various modifications or changes can be made thereto.

1. A motor comprising:
a rotor having P magnetic poles (P is an integer or 2 or more) each of which is formed by a permanent magnet, the rotor being rotatable about an axis; and
a stator having a stator core surrounding the rotor from outside in a radial direction about the axis, and three-phase coils wound on the stator core in distribution winding,
wherein the stator core has a plurality of slots in a circumferential direction about the axis,
wherein the three-phase coils have a first phase coil disposed on an outermost side in the radial direction, a second phase coil disposed on an innermost side in the radial direction, and a third phase coil disposed between the first phase coil and the second phase coil,
wherein each of the first phase coil, the second phase coil and the third phase coil has P winding portions, adjacent two winding portions of the P winding portions being inserted into one slot of the plurality of slots and extending in both directions in the circumferential direction from the one slot,
wherein the permanent magnet is magnetized by:
a first magnetizing step performed in a state where the rotor is rotated by an angle 9 in a first direction with respect to a reference position, and
a second magnetizing step performed in a state where the rotor is rotated by the angle 9 in a second direction with respect to the reference position, and
wherein in each of the first magnetizing step and the second magnetizing step, the third phase coil is opened, the first phase coil and the second phase coil are connected in series, and magnetization current is applied to the first phase coil and the second phase coil.

2. The motor according to claim 1, wherein the reference position is a rotating position of the rotor when a center of the magnetic pole of the rotor in the circumferential direction faces a center of a magnetizing flux generated by the magnetization current applied to the first phase coil and the second phase coil.

3. The motor according to claim 1, wherein a winding factor of the motor is 1.

4. The motor according to claim 1, wherein the permanent magnet is a rare earth magnet containing iron, neodymium, and boron, and further containing dysprosium or terbium, and
wherein a content of dysprosium or terbium is 4% by weight or less.

5. The motor according to claim 1, wherein the rotor has a magnet insertion hole into which the permanent magnet is inserted,
wherein, when a straight line in the radial direction that passes through a center of the magnet insertion hole in the circumferential direction is defined as a pole center line, the permanent magnet has a width W1 in a direction perpendicular to the pole center line,
wherein the magnet insertion hole has an outer edge on an outer side thereof in the radial direction, the outer edge extending in the direction perpendicular to the pole center line,
wherein the outer edge of the magnet insertion hole has a width W2 in the direction perpendicular to the pole center line, and
wherein the width W1 and the width W2 satisfy W1>W2.

6. The motor according to claim 5, wherein the rotor has a flux barrier formed to be continuous to an end of the magnet insertion hole in the circumferential direction, and
wherein the end of the magnet insertion hole in the circumferential direction is located within the flux barrier.

7. A compressor comprising:
the motor according to claim 1; and
a compression mechanism driven by the motor.

8. A refrigeration cycle apparatus comprising the compressor according to claim 7, a condenser, a decompressor, and an evaporator.

9. A magnetizing method to magnetize a permanent magnet of a motor, the motor comprising:
a rotor having P magnetic poles each of which is formed by a permanent magnet, the rotor being rotatable about an axis; and
a stator having a stator core surrounding the rotor from outside in a radial direction about the axis, and three-phase coils wound on the stator core in distribution winding,
wherein the stator core has a plurality of slots in a circumferential direction about the axis,
wherein the three-phase coils have a first phase coil disposed on an outermost side in the radial direction, a second phase coil disposed on an innermost side in the radial direction, and a third phase coil disposed between the first phase coil and the second phase coil,
wherein each of the first phase coil, the second phase coil and the third phase coil has P winding portions, adjacent two winding portions of the P winding portions being inserted into one slot of the plurality of slots and extending in both directions in the circumferential direction from the one slot,
the magnetizing method comprising:
a first magnetizing step performed in a state where the rotor is rotated by an angle θ in a first direction with respect to a reference position; and
a second magnetizing step performed in a state where the rotor is rotated by the angle θ in a second direction with respect to the reference position, and
wherein in each of the first magnetizing step and the second magnetizing step, the third phase coil is opened, the first phase coil and the second phase coil are connected in series, and magnetization current is applied to the first phase coil and the second phase coil.

10. The magnetizing method according to claim 9, wherein the reference position is a rotating position of the rotor when a center of the magnetic pole of the rotor in the circumferential direction faces a center of a magnetizing flux generated by the magnetization current applied to the first phase coil and the second phase coil.

11. The magnetizing method according to claim 9, wherein a winding factor of the motor is 1.

12. The magnetizing method according to claim 9, wherein the permanent magnet is a rare earth magnet containing iron, neodymium, and boron, and further containing dysprosium or terbium, and
wherein a content of dysprosium or terbium is 4% by weight or less.

13. A magnetizing apparatus to magnetize a permanent magnet of a motor, the motor comprising:
a rotor having P magnetic poles each of which is formed by a permanent magnet, the rotor being rotatable about an axis; and
a stator having a stator core surrounding the rotor from outside in a radial direction about the axis, and three-phase coils wound on the stator core in distribution winding,
wherein the stator core has a plurality of slots in a circumferential direction about the axis,
wherein the three-phase coils have a first phase coil disposed on an outermost side in the radial direction, a second phase coil disposed on an innermost side in the radial direction, and a third phase coil disposed between the first phase coil and the second phase coil,
wherein each of the first phase coil, the second phase coil and the third phase coil has P winding portions, adjacent two winding portions of the P winding portions being inserted into one slot of the plurality of slots and extending in both directions in the circumferential direction from the one slot,
the magnetizing apparatus performing:
a first magnetizing step performed in a state where the rotor is rotated by an angle 9 in a first direction with respect to a reference position, and
a second magnetizing step performed in a state where the rotor is rotated by the angle 9 in a second direction with respect to the reference position, and
wherein in each of the first magnetizing step and the second magnetizing step, the third phase coil is opened, the first phase coil and the second phase coil are connected in series, and magnetization current is applied to the first phase coil and the second phase coil.

14. The magnetizing apparatus according to claim 13, wherein the reference position is a rotating position of the rotor when a center of the magnetic pole of the rotor in the circumferential direction faces a center of a magnetizing flux generated by the magnetization current applied to the first phase coil and the second phase coil.

15. The magnetizing apparatus according to claim 13, wherein a winding factor of the motor is 1.

16. The magnetizing apparatus according to claim 13, wherein the permanent magnet is a rare earth magnet containing iron, neodymium, and boron, and further containing dysprosium or terbium, and
wherein a content of dysprosium or terbium is 4% by weight or less.

17. The magnetizing apparatus according to claim 13, further comprising a power source device connected to the three-phase coils of the motor and generates the magnetization current.
